(19) United States
(12) Patent Application Publication
(10) Pub. No.: US 2013/0339209 A1
(43) Pub. Date: Dec. 19, 2013

(54) SYSTEMS AND METHODS FOR MUNICIPAL SECURITIES MARKET DATA AGGREGATION AND TRADING

(71) Applicant: BOND INDEX, INC., (US)

(72) Inventor: Lourdes GERMAN, Brighton, MA (US)

(73) Assignee: BOND INDEX, INC., Brighton, MA (US)

(21) Appl. No.: 13/863,224

(22) Filed: Apr. 15, 2013

Related U.S. Application Data
(60) Provisional application No. 61/624,045, filed on Apr. 13, 2012.
(60) Provisional application No. 61/794,830, filed on Mar. 15, 2013.

(51) Int. Cl. G06Q 40/04

(52) U.S. Cl. CPC G06Q 40/04
USPC 705/37

(57) ABSTRACT

Techniques for optimizing data movement in electronic storage devices are disclosed. In one particular exemplary embodiment, the techniques may be realized as a method for municipal security data aggregation comprising receiving, via a network, municipal security data regarding a plurality of municipal securities in a primary market, aggregating, using at least one computer processor, the received municipal security data, and providing pricing information on a municipal security of the plurality of municipal securities in the primary market.

### CROSS-REFERENCE TO RELATED APPLICATIONS

This application claims priority to U.S. Provisional Application No. 61/624,045, filed Apr. 13, 2012 and to U.S. Provisional Application No. 61/794, 830, filed Mar. 15, 2013, the entire disclosures of which are each incorporated by reference herein in their entireties.

### BACKGROUND

The municipal bond market is a $3.7 trillion market. A major consistent and historical problem of the municipal market is the decentralized system that exists for collecting and disseminating disclosure, pricing, credit, trade, and market data relating to municipal securities. It is inefficient and unreliable. The financial crisis in 2008, as prior periods of financial distress in global economic markets, introduced significant dislocations in the municipal markets. Investors found it difficult to obtain basic information about municipal securities, monitor holdings, and diligence new offerings. Municipal securities such as bonds are traditionally initially offered to investors via large investment banks and virtually no transparency into these offerings is available to the general public.

### SUMMARY OF THE DISCLOSURE

Techniques for optimizing data movement in electronic storage devices are disclosed. In one particular exemplary embodiment, the techniques may be realized as a method for municipal security data aggregation comprising receiving, via a network, municipal security data regarding a plurality of municipal securities in a primary market, aggregating, using at least one computer processor, the received municipal security data, and providing pricing information on a municipal security of the plurality of municipal securities in the primary market.

In accordance with further aspects of this particular exemplary embodiment, the techniques may comprise receiving an indication of interest in purchasing the municipal security.

In accordance with further aspects of this particular exemplary embodiment, the techniques may comprise notifying a purchaser that the received indication of interest has been converted into an order.

In accordance with further aspects of this particular exemplary embodiment, the pricing information may include comparative data to evaluate the municipal security relative to a market benchmark.

In accordance with further aspects of this particular exemplary embodiment, the market benchmark may comprise at least one of: Treasury yields, Municipal AAA Yields, Municipal BBB Yields, Revenue Bond AAA yields, Revenue Bond BBB yields, Corporate Aaa yields, and Corporate Baa yields.

In accordance with further aspects of this particular exemplary embodiment, the pricing information may include comparative data to evaluate the municipal security relative to one or more of the plurality of municipal securities in a primary market.

In accordance with further aspects of this particular exemplary embodiment, the comparative data may comprise yield information.

In accordance with further aspects of this particular exemplary embodiment, the yield information may comprise yield information comparing yields of the municipal security to yields of one or more of the plurality of municipal securities having a same credit rating.

In accordance with further aspects of this particular exemplary embodiment, the yield information may comprise yield information comparing yields of the municipal security to yields of one or more of the plurality of municipal securities having a same geographic segment.

In accordance with further aspects of this particular exemplary embodiment, the yield information may comprises yield information comparing yields of the municipal security to yields of one or more of the plurality of municipal securities having a same sector.

In accordance with further aspects of this particular exemplary embodiment, the sector may comprises at least one of: general obligation, advance refunded, state appropriated debt, education—higher education, education—non-higher education, health, housing, transportation, utilities, water & sewer, and miscellaneous revenue.

In accordance with further aspects of this particular exemplary embodiment, the comparative data may comprise price information.

In accordance with further aspects of this particular exemplary embodiment, the techniques may comprise providing a search functionality configured to identify a municipal security out of the plurality of municipal securities in the primary market having a specified criteria including at least one of: a geographical attribute, a price, an issuer, a yield, a rating, a Committee on Uniform Security Identification Procedures (CUSIP) code, a source of revenues, a federal tax status, a state tax status, a duration, a purpose, an insurance status, and a call risk.

In accordance with further aspects of this particular exemplary embodiment, the techniques may comprise receiving, via a network, municipal security data regarding a plurality of municipal securities in a secondary market, aggregating, using at least one computer processor, the received municipal security data, and providing pricing information on a municipal security of the plurality of municipal securities in the secondary market.

In accordance with further aspects of this particular exemplary embodiment, the municipal security data may be received via periodic feeds providing data on at least one of: a daily basis, an hourly basis, and a real time basis.

In accordance with further aspects of this particular exemplary embodiment, the techniques may comprise importing data modeling a security portfolio, and providing functionality to model an impact of adding a municipal security of the plurality of municipal securities to the security portfolio.

In accordance with further aspects of this particular exemplary embodiment, the techniques may comprise identifying, using specified criteria, a municipal security of the plurality of municipal securities.

In accordance with further aspects of this particular exemplary embodiment, the one or more specified criteria may include maturity date information for one or more of the plurality of municipal securities, wherein the maturity date information may allow laddering modeling functionality.

In accordance with further aspects of this particular exemplary embodiment, the techniques may comprise archiving data, using at least one database, for the plurality of municipal securities in the primary market.

In accordance with further aspects of this particular exemplary embodiment, the techniques may comprise evaluating at least one issuer of a municipal security of the plurality of municipal securities on one or more metrics using the archived data.

In accordance with further aspects of this particular exemplary embodiment, the one or more metrics may comprise net interest cost for a financing, true interest cost for a deal, a comparison of yields and pricing for offerings that come to market in a same time frame of a similar credit quality, similar program, and similar geographic region to a financing.

In another particular exemplary embodiment, the techniques may be realized as an article of manufacture for municipal security data aggregation. The article of manufacture may comprise at least one non-transitory processor readable storage medium, and instructions stored on the at least one medium. The instructions may be configured to be readable from the at least one medium by at least one processor and thereby cause the at least one processor to operate so as to: receive, via a network, municipal security data regarding a plurality of municipal securities in a primary market, aggregate, using at least one computer processor, the received municipal security data, and provide pricing information on a municipal security of the plurality of municipal securities in the primary market.

In yet another particular exemplary embodiment, the techniques may be realized as a system for municipal security data aggregation comprising one or more processors communicatively coupled to a network. The one or more processors may be configured to receive, via a network, municipal security data regarding a plurality of municipal securities in a primary market, aggregate the received municipal security data, and provide pricing information on a municipal security of the plurality of municipal securities in the primary market.

In accordance with further aspects of this particular exemplary embodiment, the one or more processors may be configured to receive an indication of interest in purchasing the municipal security.

In accordance with further aspects of this particular exemplary embodiment, the pricing information may include comparative data to evaluate the municipal security relative to a market benchmark.

In accordance with further aspects of this particular exemplary embodiment, the pricing information includes comparative data to evaluate the municipal security relative to one or more of the plurality of municipal securities in a primary market.

In accordance with further aspects of this particular exemplary embodiment, the comparative data comprises yield information comparing yields of the municipal security to yields of one or more of the plurality of municipal securities having at least one of a same credit rating, a same geographic segment, and a same sector.

In accordance with further aspects of this particular exemplary embodiment, the one or more processors may be configured to provide a search functionality configured to identify a municipal security out of the plurality of municipal securities in the primary market having a specified criteria including at least one of: a geographical attribute, a price, an issuer, a yield, a rating, a Committee on Uniform Security Identification Procedures (CUSIP) code, a source of revenues, a federal tax status, a state tax status, a duration, a purpose, an insurance status, and a call risk.

In accordance with further aspects of this particular exemplary embodiment, the one or more processors may be configured to import data modeling a security portfolio, and provide functionality to model an impact of adding a municipal security of the plurality of municipal securities to the security portfolio.

The present disclosure will now be described in more detail with reference to exemplary embodiments thereof as shown in the accompanying drawings. While the present disclosure is described below with reference to exemplary embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be exemplary only.

FIG. 1 shows a block diagram depicting a network architecture 100 for security data aggregation and trading, in accordance with an embodiment of the present disclosure.

FIG. 2 depicts a block diagram of a computer system in accordance with an embodiment of the present disclosure.

FIG. 3 shows a module for security data aggregation and trading, in accordance with an embodiment of the present disclosure.

FIG. 4 depicts a method for security data aggregation and trading, in accordance with an embodiment of the present disclosure.

FIG. 5 depicts a method for security data aggregation and trading, in accordance with an embodiment of the present disclosure.

FIG. 6 shows a block diagram depicting a network architecture for security data aggregation and trading, in accordance with an embodiment of the present disclosure.

FIG. 7 shows a block diagram depicting a method for verification of municipal securities, in accordance with an embodiment of the present disclosure.

FIG. 8 depicts a user interface for initiating security trading, in accordance with an embodiment of the present disclosure.

FIG. 9 depicts a user interface for confirmation of initiation of security trading, in accordance with an embodiment of the present disclosure.

FIG. 10 depicts a user interface for security trading order entry, in accordance with an embodiment of the present disclosure.

FIG. 11 depicts a user interface for security trading order entry, in accordance with an embodiment of the present disclosure.

FIG. 12 depicts a user interface for security trading order terms, in accordance with an embodiment of the present disclosure.

FIG. 13 depicts a user interface for security trading order confirmation, in accordance with an embodiment of the present disclosure.

FIG. 14 depicts a user interface for viewing the volume of and the deals in a municipal market, in accordance with an embodiment of the present disclosure.

FIG. 15 depicts a user interface for entering securities search and/or filter criteria, in accordance with an embodiment of the present disclosure.

FIG. 16 depicts a user interface for viewing the details of a municipal security offering, in accordance with an embodiment of the present disclosure.

FIG. 17 depicts a user interface for municipal security deals, in accordance with an embodiment of the present disclosure.

FIG. 18 depicts a user interface for comparing municipal securities, in accordance with an embodiment of the present disclosure.

FIG. 19 depicts a user interface for viewing new municipal security offerings of a particular investment bank, in accordance with an embodiment of the present disclosure.

FIG. 20 depicts a user interface for viewing market benchmarks, in accordance with an embodiment of the present disclosure.

FIG. 21A depicts a user interface for advertising municipal security offerings, in accordance with an embodiment of the present disclosure.

FIG. 21B depicts a user interface for advertising municipal security offerings, in accordance with an embodiment of the present disclosure.

FIG. 21C depicts a user interface for advertising municipal security offerings, in accordance with an embodiment of the present disclosure.

FIG. 22 depicts a user interface for viewing municipal security offering details, in accordance with an embodiment of the present disclosure.

FIG. 23 depicts a mobile user interface displaying a municipal security offering display including measurements of intra-day trading, in accordance with an embodiment of the present disclosure.

### DETAILED DESCRIPTION OF EXEMPLARY EMBODIMENTS

The present disclosure relates to a municipal security market data aggregator and trading platform. Embodiments may provide municipal security market information in a primary market (e.g., new deals for sale at their initial public offering) and secondary market (e.g., deals for sale in the over-the-counter market from customer to customer or dealer to dealer after initial offering). Municipal security information may be aggregated and processed to provide comparative indications of price, yield, rating, or other security attributes to an individual investor, an institutional investor, or another party. Such security information may be presented by market segment, against overall market benchmarks, or in other user configurable displays. Embodiments may allow for the placement of indications of interest for a security being offered in a primary market by an individual investor, an institutional investor, or another party.

In accordance with one or more embodiments, transparency in the fixed income market for individual investors is provided. The problem of fixed income market fragmentation is addressed by creating the world's first electronic facility that assembles, aggregates, and disseminates municipal market information that facilitates education and an automated electronic trading function where individual investors and institutional investment professionals within this sector of the market are able to submit instant indications of interest during the open order period where a municipal security is being sold to any one of the managers in the underwriting syndicate participating in the offering. In accordance with one or more embodiments, the world's first aggregator of municipal market data provides a better and more efficient municipal market that informs and engages a key source of market liquidity, the individual investor.

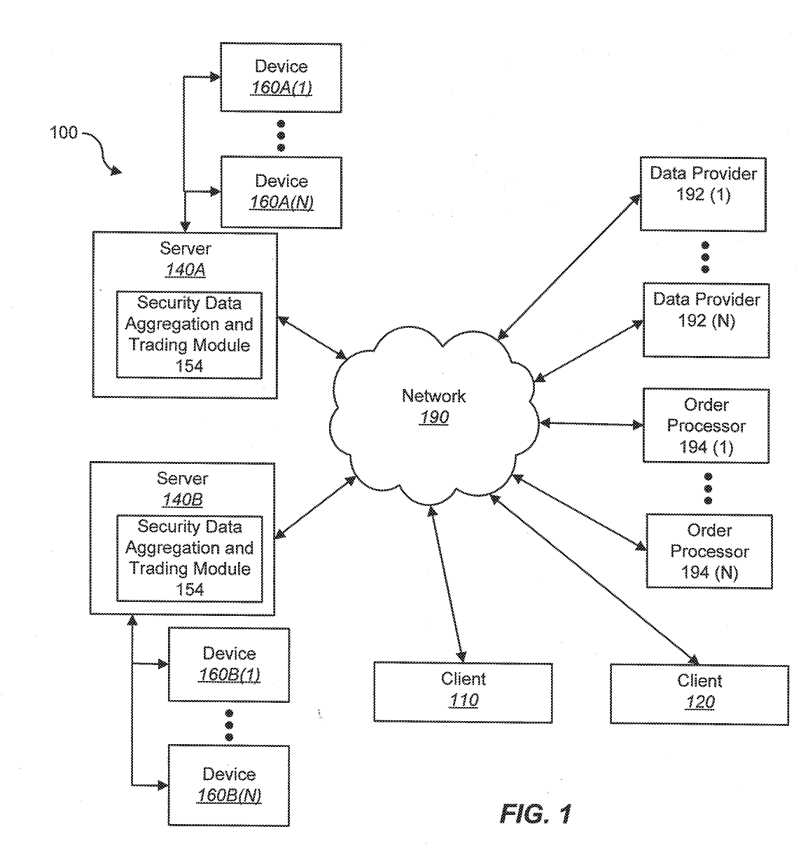

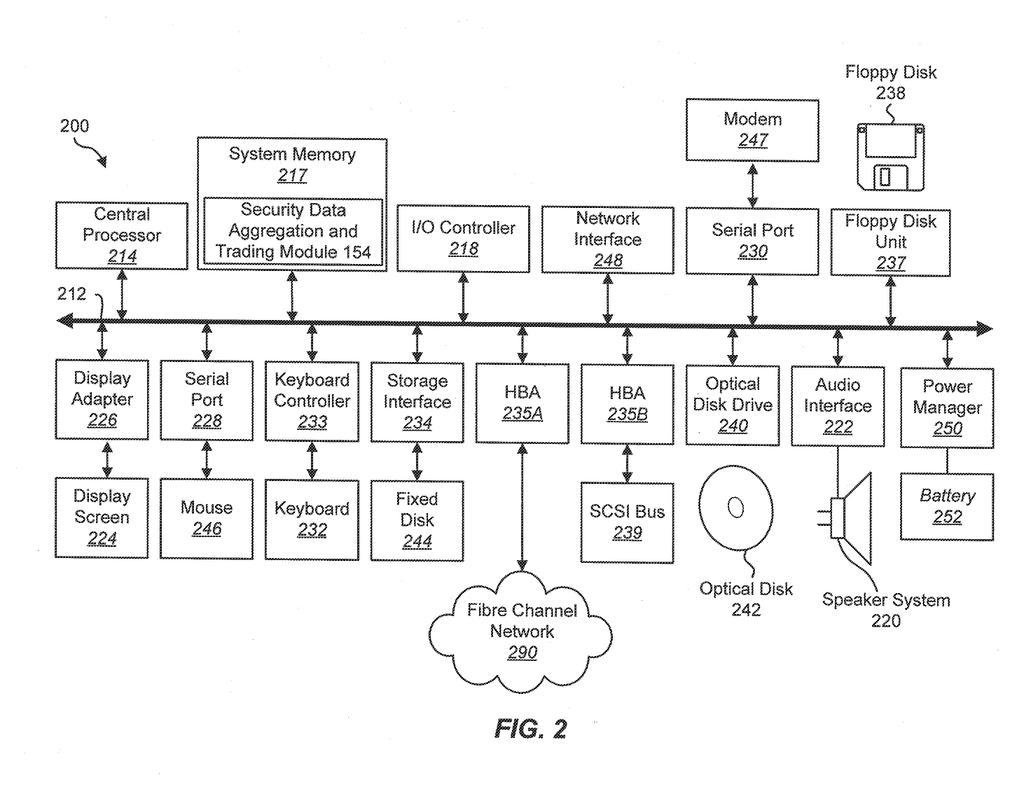

Turning now to the drawings, FIG. 1 shows a block diagram depicting a network architecture 100 for security data aggregation and trading, in accordance with an embodiment of the present disclosure. FIG. 1 is a simplified view of network architecture 100, which may include additional elements that are not depicted. Network architecture 100 may contain client systems 110 and 120, as well as servers 140A and 140B (one or more of which may be implemented using computer system 200 shown in FIG. 2). Client systems 110 and 120 may be communicatively coupled to a network 190. Server 140A may be communicatively coupled to storage devices 160A(1)-(N), and server 140B may be communicatively coupled to storage devices 160B(1)-(N). Servers 140A and 140B may contain a management module (e.g., Security data aggregation and trading module 154). Data providers 192(1)-(N) may be communicatively coupled to network 190. Order processors 194(1)-(N) may also be communicatively coupled to network 190.

With reference to computer system 200 of FIG. 2, modem 247, network interface 248, or some other method may be used to provide connectivity from one or more of client systems 110 and 120 to network 190. Client systems 110 and 120 may be able to access information on server 140A or 140B using, for example, a web browser or other client software (not shown) as a platform. Such a platform may allow client systems 110 and 120 to access data hosted by server 140A or 140B or one of storage devices 160A(1)-(N) and/or 160B(1)-(N).

Network 190 may be a local area network (LAN), a wide area network (WAN), the Internet, a cellular network, a satellite network, or other networks that permit communication between clients 110, 120, servers 140, and other devices communicatively coupled to network 190. Network 190 may further include one, or any number, of the exemplary types of networks mentioned above operating as a stand-alone network or in cooperation with each other. Network 190 may utilize one or more protocols of one or more clients or servers to which they are communicatively coupled. Network 190 may translate to or from other protocols to one or more protocols of network devices. Although network 190 is depicted as one network, it should be appreciated that according to one or more embodiments, network 190 may comprise a plurality of interconnected networks.

Storage devices 160A(1)-(N) and/or 160B(1)-(N) may be network accessible storage and may be local, remote, or a combination thereof to server 140A or 140B. Storage devices 160A(1)-(N) and/or 160B(1)-(N) may utilize a redundant array of inexpensive disks (“RAID”), magnetic tape, disk, a storage area network (“SAN”), an internet small computer systems interface (“iSCSI”) SAN, a Fibre Channel SAN, a common Internet File System (“CIFS”), network attached storage (“NAS”), a network file system (“NFS”), optical based storage, or other computer accessible storage. Storage devices 160A(1)-(N) and/or 160B(1)-(N) may be used for backup or archival purposes.

According to some embodiments, clients 110 and 120 may be smartphones, PDAs, desktop computers, a laptop computers, servers, other computers, or other devices coupled via a wireless or wired connection to network 190. Clients 110 and 120 may receive data from user input, a database, a file, a web service, and/or an application programming interface.

Servers 140A and 140B may be application servers, archival platforms, backup servers, network storage devices, media servers, email servers, document management platforms, enterprise search servers, or other devices communicatively coupled to network 190. Servers 140A and 140B may utilize one of storage devices 160A(1)-(N) and/or 160B(1)-(N) for the storage of application data, backup data, or other data. Servers 140A and 140B may be hosts, such as an application server, which may process data traveling between clients 110 and 120 and a backup platform, a backup process, and/or storage. According to some embodiments, servers 140A and 140B may be platforms used for backing up and/or archiving data. One or more portions of data may be backed up or archived based on a backup policy and/or an archive applied, attributes associated with the data source, space available for backup, space available at the data source, or other factors.

Data providers 192(1)-(N) may provide municipal security data from one or more sources. According to some embodiments, data providers 192(1)-(N) may be external municipal securities market data providers (e.g., Interactive Data Corporation, Image Master, or another financial market data provider). Data providers 192(1)-(N) may provide municipal security data for primary markets and/or secondary markets. Data providers 192(1)-(N) may provide one or more interfaces, filters, converters, formatting modules, or other data processing components to prepare data for Server 140 and/or Server 140B. Data may be provided periodically (e.g, daily, hourly, real time, or other increments), in batch or bulk, in response to a query or request (e.g., initiated by Server 140A), or event driven (e.g., in response to an initial offering, a news event, etc.).

Order processors 194(1)-(N) may receive an indication of interest to buy a security in a primary market. Order processors 194(1)-(N) may receive orders to buy one or more securities in a secondary market. According to some embodiments, Order processors 194(1)-(N) may be associated with one or more banks for processing an order. Order processors 194(1)-(N) may perform one or more order validation actions including, for example, identity verification, verification of part the account verified, and available liquid funds in cash may be verified before the order is submitted to the investment bank and senior manager running an offering.

According to some embodiments, clients 110 and/or 120 may contain one or more portions of software for aggregating municipal security information, modeling municipal security information and/or trading municipal securities such as, for example, Security data aggregation and trading module 154. As illustrated, one or more portions of Security data aggregation and trading module 154 may reside at a network centric location. For example, server 140A may be a server, a firewall, a gateway, or other network element that may perform one or more actions to identify security information. According to some embodiments, network 190 may be an external network (e.g., the Internet) and server 140A may be a gateway or firewall between one or more internal components and clients and the external network.

In some embodiments, security data aggregation and trading module 154 may aggregate data related to municipal securities in the market and communicate it to investors in a free, open, transparent web platform. Security data aggregation and trading module 154 may aggregate and synthesize data provide investors with educational tools, access to price discovery, and a unified location to go to find out the true market price and publically available information for any municipal security. In some embodiments, a separate web platform allows users viewing municipal securities for primary market new offerings to make indications of interest to buy certain securities and submit those indications of interest to underwriters involved in different deals, serving as the first electronic centralized alternative trading platform for municipal bonds that caters to the individual investor market. Still other embodiments relate to the searching of securities and the tracking of customer preferences which can be leveraged for portfolio strategies, and also to display municipal market current available issuance by geographic segmentation.

According to some embodiments, clients 120 and 130 may be mobile devices and security data aggregation and trading module 154 may be implemented on one or more mobile platforms including, but not limited to Android, iOS, WebOS, Windows Mobile, Blackberry OS, and Symbian. Security data aggregation and trading module 154 may be implemented on top of one or more platforms such as, for example, Internet Explorer, FireFox, Chrome, and Safari. Security data aggregation and trading module 154 may be distributed online free of charge (e.g., via an app store or a website). In some embodiments, security data aggregation and trading module 154 may be licensed in different manners (e.g., free for individual investors but under a fee for large investment banks or institutional investors.) In some embodiments, security data aggregation and trading module 154 may implemented on a desktop client.

Historically, data on primary market municipal market sales may have not been publicly available. Security data aggregation and trading module 154 may provide the ability to aggregate data across available fixed income market information into a single client experience for both the primary market (e.g., new deals for sale at their initial public offering) and secondary market (e.g., deals for sale in the over-the-counter market from customer to customer or dealer to dealer after initial offering).

Security data aggregation and trading module 154 may receive data feeds of municipal securities in the primary market and aggregate, process, and present it. For example, security data aggregation and trading module 154 may receive information from data providers 192(1)-192(N) about securities in the primary market including, for example: the name of new issues coming to the market when they are announced (e.g., par, pricing date, issuer, public rating); preliminary official statements related to new issues; pricing information on the date of the retail order period and institutional order period for new issues; final pricing information for new issues; final Official Statements for new issues; final credit rating for new issues; publically available issuer disclosures; financial information; material events reporting available outside of the official statement reported by the issuer to Nationally Recognized Municipal Securities Information Repositorys; and trading activity related to the new issue and relating to the securities of the issuer generally occurring in real time in the secondary market, displayed as end of day intra-day trading information for new issues which shows a graphical representation of yield compression or expansion measured against the final offering yield for the deal.

In accordance with one or more embodiments, security data aggregation and trading module 154 may aggregate information from data providers 192(1)-192(N) about securities in the secondary market including, for example: final official statements; initial and current pricing; initial and current yield; initial credit ratings; current ratings and ratings history since issuance; current pricing and pricing history since issuance in secondary market trades; history of disclosure filings by an issuer; the issuer's ability to call the security for early redemption; the security for the issue; publically available issuer disclosure and financial information available outside of the official statement and submitted by the issuer to Nationally Recognized Municipal Securities Information Repositories.

In some embodiments, the data gathered from one or more data feeds may be disseminated via security data aggregation and trading module 154 where anyone may view a plurality of deals and the offerings in the municipal market as well as the secondary market trading history for issuers in the market (e.g., all available offerings for one or more days). security data aggregation and trading module 154 may provide a single portal for investors (e.g., individual investors, institutional investors, or other parties) to know the market for any security. Security data aggregation and trading module 154 may archive data as well as receive current market data. According to some embodiments, security data aggregation and trading module 154 may provide market data for any security at any snapshot in time, 24 hours per day, 7 days per week, with open and transparent pricing and disclosure information for every issuer in the municipal market offered for free. Security data aggregation and trading module 154 may also allow customers to follow particular deals and see how they change over time during different phases of primary market pricing and secondary market trading.

In at least some embodiments, security data aggregation and trading module 154 may also allow for data that is aggregated to be sorted and presented by issuer, by state, by geographic sector, by credit quality, by purpose, by time horizon, and by par amount—allowing customers to see the universe of securities sorted by different characteristics of interest to them and also sorted by different vantage points in the market. One specific, non-limiting algorithm described below (“MuniSort” Algorithm) may facilitate this function. Security data aggregation and trading module 154 may use the MuniSort Algorithm or other algorithms to provide a method of searching and sorting the aggregated data in a way that is meaningful for users. One or more portions of security data aggregation and trading module 154 (e.g., a client interface provided on a mobile device) may link to a web portal and provide market data for viewing available on a cell phone, a tablet, an e-reader, or another mobile device.

In accordance with one or more embodiments, security data aggregation and trading module 154 may provide functionality allowing a user to import or upload an investment portfolio. For example, a link or other interface may be provided to collect and upload investor portfolios. Security data aggregation and trading module 154 may interface with one or more banks, brokerages, or other financial institutions to import a financial portfolio.

In at least one embodiment, security data aggregation and trading module 154 may allow creation and modeling of a new hypothetical portfolio. For example, an investor may enter specific criteria indicative of their desired portfolio construction characteristics. Security data aggregation and trading module 154 may allow a customer to integrate any security on a hypothetical basis to their portfolio (whether it is a new issue or a secondary market issue) and see how it will affect the portfolio's performance and credit quality or composition. Security data aggregation and trading module 154 may function to allow customers to spend time discovering trade ideas quickly and easily with the portal to the entire market at their fingertips.

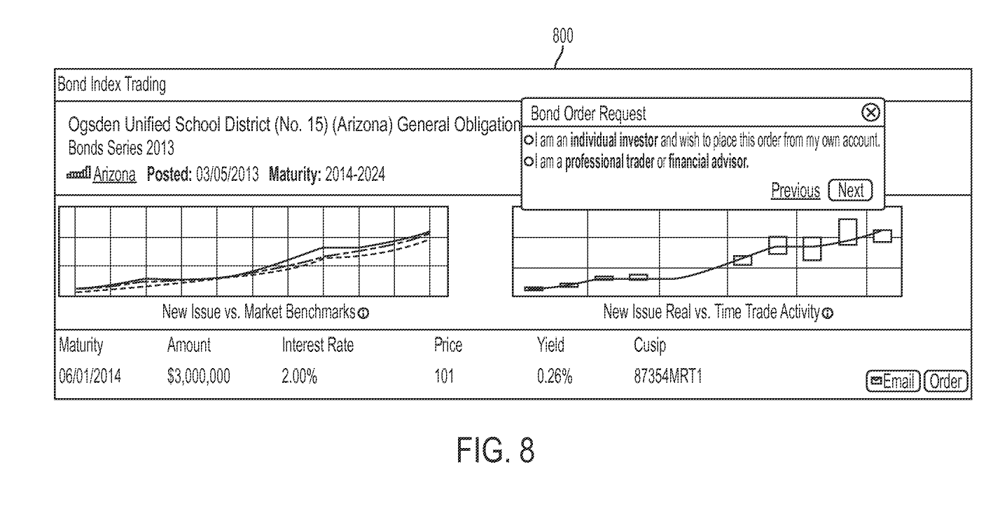

Security data aggregation and trading module 154 may provide reports and graphs to view the structure of a portfolio with the new securities in it or existing securities and generate ideas. Reports and graphs may be of actual portfolios, modeled portfolios, or a combination (e.g., a user portfolio with hypothetical security purchases to model the impact of such purchases). Examples of graphs may include a graph of maturity distribution that shows where bonds may be added or reduced to maintain a laddered portfolio and portfolio views by one or more of: rating, yield, geography or by sector to identify gaps in holdings. Sectors may include, for example, general obligation, advance refunded, state appropriated debt, education—higher education, education—non-higher education, health, housing, transportation, utilities, water & sewer, and miscellaneous revenue. User interfaces are discussed in greater detail below in reference to FIGS. 8-12.

Security data aggregation and trading module 154 may provide one or more algorithms to improve views and comparisons of prospective securities. One non-limiting algorithm described below (“MuniRank” Algorithm) may facilitate the portfolio function by helping the user search for a bond with one or more common attributes such as, for example: geography, price, issuer, yield, ratings, Committee on Uniform Security Identification Procedures (CUSIP) code, source of revenues, federal tax status, state tax status, duration, purpose, insured status, and call risk.

Using this powerful searching capability may provide lists of securities that are similar in their attributes to that desired and meaningful for the user. It can also provide customers with the ability to create model portfolios with a singular focus, like credit or duration, as well as create model bond ladders, and watch performance over time without actually purchasing a security. Investors may therefore have all the tools to determine where and how fixed income securities might fit into their portfolio.

In accordance with one or more embodiments, security data aggregation and trading module 154 may generate proprietary yield curves that leverage primary market data. A proprietary curve fitting model may be used to record yield levels across the entire spectrum of maturities available in the new issue universe or in one or more user specified segments of a market. Such proprietary methodology may enable the generation of a curve that is capable of showing the changing average yields by one or more attributes such as, for example, credit quality, geography, and sector based on end-of-day new issue pricing every day. In some embodiments, security data aggregation and trading module 154 may provide yield curves that are based on actual pricing data on the close of every business day based on market activity for issuers in the nation by credit quality tied to the global ratings scale of the major rating agencies—Standard & Poor's, Moody's and Fitch. The yield curve may use options adjusted analysis of other identifying criteria of municipal securities. Security data aggregation and trading module 154 may allow customers to see a new data-line market index on the web portal and have a benchmark against which to compare yields and pricing information for new issue securities and secondary market securities. Benchmarks may include, for example, Treasury yields, Municipal AAA Yields, Municipal BBB Yields, Revenue Bond AAA yields, Revenue Bond BBB yields, Corporate Aaa yields, and Corporate Baa yields. The yield curve may comprise yield information comparing yields of the municipal security to yields of one or more of the plurality of municipal securities having a same credit rating.

In accordance with one or more embodiments, security data aggregation and trading module 154 may provide a web-based trading portal that serves as a venue for matching the “buy” orders of customers who view primary market issues on the web platform and wish to place indications of interest to purchase such securities during retail order periods. Users may be able to view a desired security and with one click submit an indication of interest to the bank participating in the deal. In some embodiments, if a user has an existing brokerage and trading account at the bank, a user may be able to authenticate via a bank and receive approval for an order. If a user does not have a brokerage and trading account they may be able to link to an investment bank who is participating in the deal, select a dealer to open an account with, and submit their indication of interest for the security after they have opened the account.

Security data aggregation and trading module 154 may gather and submit instant indications of interest during the duration of the retail order period. Indications of interest may be submitted to an investment bank where a customer holds an account. The account may be in a format that is customized and interfaces with the particular bank's existing municipal market electronic order entry trading applications for new issue orders (Bloomberg, Ipreo, etc.). Such capability may also extend to secondary market orders as well so that customers viewing the universe of securities available in the municipal secondary market may have the capability of submitting an indication of interest to the bank offering the security on behalf of a customer, linked via an alternative trading platform, or other alternative trading systems, which inventory the outstanding secondary market offerings.

In accordance with one or more embodiments, data that is aggregated may be searched by users. There are approximately $3.7 trillion of outstanding municipal securities, and billions of new primary market issuance every year by thousands of issuers. Such data may be aggregated in accordance with various embodiments. With millions of existing and new municipal bond securities, hundreds of factors may be used to determine best search results, and keep the search clean and efficient for any customer using the web portal. With a thorough list of criteria including but not limited to geography, price, issuer, yield, ratings, cusip, source of revenues, federal tax status, state tax status, duration, purpose, insured status, and call risk, investors may search and see the universe of securities sorted by different characteristics of interest to them and also sorted by different market based factors in a way that is meaningful and efficient for them.

In accordance with one or more embodiments, a portfolio function may be facilitated with a set of rules that recognize attributes identified by a user. A portfolio function may also be facilitated with attributes that inure to a portfolio (an existing one that is uploaded on the web platform, a new one created on the web platform, or indicative portfolio construction criteria) by a user and it may help identify bonds in the primary market or secondary market with common attributes such as maturity, rating, yield, coupon, etc. of interest to them or in their own mock or existing portfolio. Using this powerful searching capability may provide lists of securities that are similar in their attributes to their existing holdings or new ones that are desired and meaningful for the user.

In some embodiments, security data aggregation and trading module 154 may contain a database or other storage for archiving municipal security data. Archived municipal security data may be queried by a user. Municipal security data from the archived database may be used to evaluate a primary market may be used to evaluate a primary market offering. For example, bonds with similar attributes may be expected to price similarly, and a user of module 154 would be able to compare the pricing history for an issuer's prior issued bonds against the pricing of the issuer's new primary market offering of a similar credit quality, identical investment duration, identical program, and similar security and assess the price of the primary market offering. Module 154 may also contain criteria that allows an issuer of the municipal security to evaluate the performance of the investment bank serving as the syndicator of the offering, by recording and displaying certain key statistics related to an offering (including, for example, the net interest cost for the financing, the true interest cost for the deal) and allowing for the comparison of yields and pricing for offerings that come to market in the same time frame of a similar credit quality, similar program, and/or similar geographic region to their financing.

FIG. 2 depicts a block diagram of a computer system 200 in accordance with an embodiment of the present disclosure. Computer system 200 is suitable for implementing techniques in accordance with the present disclosure. Computer system 200 may include a bus 212 which may interconnect major subsystems of computer system 210, such as a central processor 214, a system memory 217 (e.g. RAM (Random Access Memory), ROM (Read Only Memory), flash RAM, or the like), an Input/Output (I/O) controller 218, an external audio device, such as a speaker system 220 via an audio output interface 222, an external device, such as a display screen 224 via display adapter 226, serial ports 228 and 230, a keyboard 232 (interfaced via a keyboard controller 233), a storage interface 234, a floppy disk drive 237 operative to receive a floppy disk 238, a host bus adapter (HBA) interface card 235A operative to connect with a Fibre Channel network 290, a host bus adapter (HBA) interface card 235B operative to connect to a SCSI bus 239, and an optical disk drive 240 operative to receive an optical disk 242. Also included may be a mouse 246 (or other point-and-click device, coupled to bus 212 via serial port 228), a modem 247 (coupled to bus 212 via serial port 230), network interface 248 (coupled directly to bus 212), power manager 250, and battery 252.

Bus 212 allows data communication between central processor 214 and system memory 217, which may include read-only memory (ROM) or flash memory (neither shown), and random access memory (RAM) (not shown), as previously noted. The RAM is may be the main memory into which the operating system and application programs may be loaded. The ROM or flash memory can contain, among other code, the Basic Input-Output system (BIOS) which controls basic hardware operation such as the interaction with peripheral components. Applications resident with computer system 210 may be stored on and accessed via a computer readable medium, such as a hard disk drive (e.g., fixed disk 244), an optical drive (e.g., optical drive 240), a floppy disk unit 237, or other storage medium. For example, Security data aggregation and trading module 154 may be resident in system memory 217.

Storage interface 234, as with the other storage interfaces of computer system 210, can connect to a standard computer readable medium for storage and/or retrieval of information, such as a fixed disk drive 244. Fixed disk drive 244 may be a part of computer system 210 or may be separate and accessed through other interface systems. Modem 247 may provide a direct connection to a remote server via a telephone link or to the Internet via an internet service provider (ISP). Network interface 248 may provide a direct connection to a remote server via a direct network link to the Internet via a POP (point of presence). Network interface 248 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 2 need not be present to practice the present disclosure. The devices and subsystems can be interconnected in different ways from that shown in FIG. 2. Code to implement the present disclosure may be stored in computer-readable storage media such as one or more of system memory 217, fixed disk 244, optical disk 242, or floppy disk 238. Code to implement the present disclosure may also be received via one or more interfaces and stored in memory. The operating system provided on computer system 210 may be MS-DOS®, MS-WINDOWS®, OS/2®, OS X®, UNIX®, Linux®, or another known operating system.

Power manager 250 may monitor a power level of battery 252. Power manager 250 may provide one or more APIs (Application Programming Interfaces) to allow determination of a power level, of a time window remaining prior to shutdown of computer system 200, a power consumption rate, an indicator of whether computer system is on mains (e.g., AC Power) or battery power, and other power related information. According to some embodiments, APIs of power manager 250 may be accessible remotely (e.g., accessible to a remote backup management module via a network connection). According to some embodiments, battery 252 may be an Uninterruptable Power Supply (UPS) located either local to or remote from computer system 200. In such embodiments, power manager 250 may provide information about a power level of an UPS.

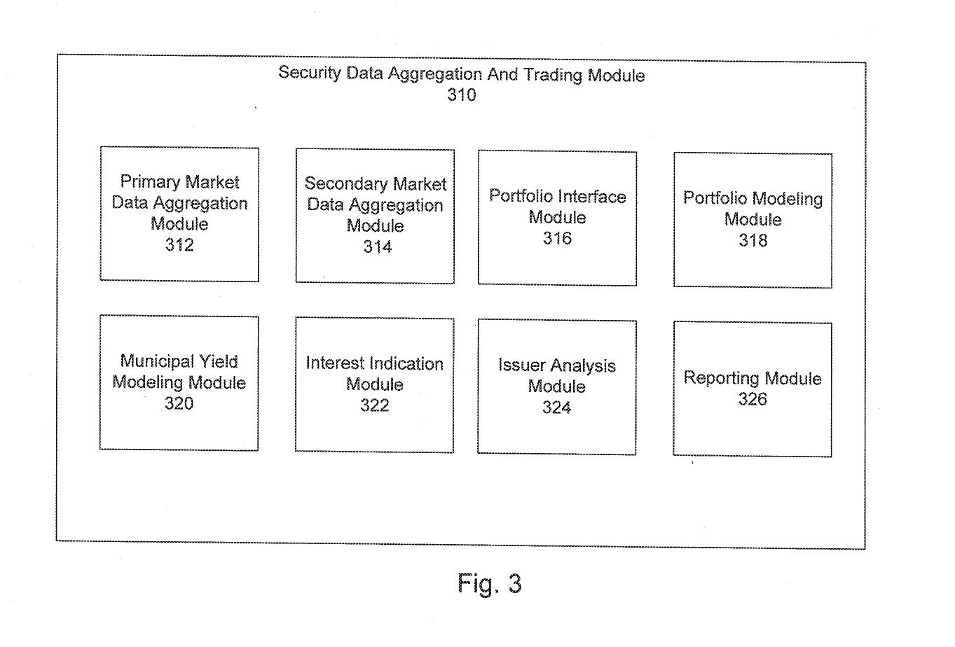

Referring to FIG. 3, there is shown a security data aggregation and trading module 310 in accordance with an embodiment of the present disclosure. As illustrated, the security data aggregation and trading module 310 may contain one or more components including primary market data aggregation module 312, secondary market data aggregation module 314, portfolio interface module 316, portfolio modeling module 318, municipal yield modeling module 320, interest indication module 322, issuer analysis module 324, and reporting module 326.

The description below describes network elements, computers, and/or components of a system and method for improving security data aggregation and trading that may include one or more modules. As used herein, the term “module” may be understood to refer to computing software, firmware, hardware, and/or various combinations thereof. Modules, however, are not to be interpreted as software which is not implemented on hardware, firmware, or recorded on a processor readable recordable storage medium (i.e., modules are not software per se). It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices.

Primary market data aggregation module 312 may gather municipal security data from one or more sources. According to some embodiments, primary market data aggregation module 312 may gather primary municipal securities market data from one or more data providers (e.g., Interactive Data Corporation, Image Master, or another financial market data provider). Primary market data aggregation module 312 may provide one or more interfaces, filters, converters, formatting modules, or other data processing components to prepare data. Data may be provided periodically (e.g, daily, hourly, real time, or other increments), in batch or bulk, in response to a query or request, or event driven (e.g., in response to an initial offering, a news event, etc.).

Primary market data aggregation module 312 may receive data feeds of municipal securities in the primary market and aggregate, and process it. For example, primary market data aggregation module 312 may receive information from data providers about securities in the primary market including, for example: the name of new issues coming to the market when they are announced (e.g., par, pricing date, issuer, public rating); preliminary official statements related to new issues; pricing information on the date of the retail order period and institutional order period for new issues; final pricing information for new issues; final Official Statements for new issues; final credit rating for new issues; publically available issuer disclosures; financial information; material events reporting available for the issuer on Nationally Recognized Municipal Securities Information Repositorys; and trading activity related to the new issue and relating to the securities of the issuer generally occurring in real time in the secondary market, end of day intra-day trading information for new issues; and a graphical representation of spread dynamics showing the new issue yields through pricing against changing daily market benchmarks for treasury bonds and credit quality benchmarks.

Secondary market data aggregation module 314 may receive municipal security data from one or more sources. According to some embodiments, secondary market data aggregation module 314 may receive secondary municipal securities market data from one or more data providers (e.g., Interactive Data Corporation, Image Master, or another financial market data provider). Secondary market data aggregation module 314 may provide one or more interfaces, filters, converters, formatting modules, or other data processing components to prepare data. Data may be provided periodically (e.g, daily, hourly, real time, or other increments), in batch or bulk, in response to a query or request, or event driven (e.g., in response to an initial offering, a news event, etc.).

In accordance with one or more embodiments, secondary market data aggregation module 314 may receive information about securities in the secondary market including, for example: final official statements; initial pricing; initial credit ratings; current ratings and ratings history since issuance; current pricing and pricing history since issuance in secondary market trades; history of disclosure filings by an issuer; publically available issuer disclosure and financial information available outside of the official statement for the issuer filed with the Nationally Recognized Municipal Securities Information Repositorys; and secondary market offerings available for purchase listed on one or more municipal secondary market alternative trading systems.

Portfolio interface module 316 may interface with one or more financial institutions to receive and/or import portfolio models. For example, a user may authenticate with their broker, investment bank, or other financial institution and import their portfolio data. Portfolio data may be imported using Extensible Markup Language (XML) feeds, JavaScript Object Notation (JSON) data, or other formats. Data transfers may be made using HTTP, FTP, or other protocols.

Portfolio modeling module 318 may allow creation and modeling of a new hypothetical portfolio. For example, an investor may enter specific criteria indicative of their desired portfolio construction characteristics. Portfolio modeling module 318 may allow a customer to integrate any security on a hypothetical basis to their portfolio (whether it is a new issue or a secondary market issue) and see how it will affect the portfolio's performance and credit quality or composition. Portfolio modeling module 318 may function to allow customers to spend time discovering trade ideas quickly and easily with the portal to the entire market at their fingertips.

Portfolio modeling module 318 may provide one or more algorithms to improve views and comparisons of prospective securities. One non-limiting algorithm described below (“MuniRank” Algorithm) may facilitate the portfolio function by helping the user search for a bond with one or more common attributes such as, for example: geography, price, issuer, yield, ratings, Committee on Uniform Security Identification Procedures (CUSIP) code, source of revenues, federal tax status, state tax status, duration, purpose, insured status, and call risk. Using this powerful searching capability may provide lists of securities that are similar in their attributes to that desired and meaningful for the user. It can also provide customers with the ability to create model portfolios with a singular focus, like credit or duration, as well as create model bond ladders, and watch performance over time without actually purchasing a security. Investors may therefore have all the tools to determine where and how fixed income securities might fit into their portfolio.

Municipal yield modeling module 320 may generate proprietary yield curves that leverage primary market data. A proprietary curve fitting model may be used to record yield levels across the entire spectrum of maturities available in the new issue universe or in one or more user specified segments of a market. Such proprietary methodology may enable the generation of a curve that is capable of showing the changing average yields by one or more attributes such as, for example, credit quality, geography, and sector based on end-of-day new issue pricing every day. In some embodiments, municipal yield modeling module 320 may provide yield curves that are based on actual pricing data on the close of every business day based on market activity for issuers in the nation by credit quality tied to the global ratings scale of the major rating agencies—Standard & Poor's, Moody's and Fitch. The yield curve may use options adjusted analysis of other identifying criteria of municipal securities. Municipal yield modeling module 320 may allow customers to see a new data-line market index on the web portal and have a benchmark against which to compare yields and pricing information for new issue securities and secondary market securities. Benchmarks may include, for example, Treasury yields, Municipal AAA Yields, Municipal BBB Yields, Revenue Bond AAA yields, Revenue Bond BBB yields, Corporate Aaa yields, and Corporate Baa yields. The yield curve may comprise yield information comparing yields of the municipal security to yields of one or more of the plurality of municipal securities having a same credit rating.

Interest indication module 322 may provide functionality allowing individual investors and institutional investment professionals to submit instant indications of interest for a municipal security during the open order period in the primary market. According to some embodiments, interest indication module 322 may receive orders to buy one or more securities in a secondary market. Interest indication module 322 may be associated with one or more banks for processing an order. Interest indication module 322 may perform one or more order validation actions including, for example, identity verification, verification of ownership of the account verified, and available liquid funds in cash may be verified before the order is submitted to the investment bank and senior manager running an offering.

Issuer analysis module 324 may be used to evaluate an issuing syndicate or an investment bank via the comparison of one or more metrics. For example, bonds with similar attributes may be expected to price similarly. Module 324 may also contain criteria that allows an issuer of the municipal security to evaluate the performance of the investment bank serving as the syndicator of the offering, by recording and displaying certain key statistics related to an offering (including, for example, the net interest cost for the financing, the true interest cost for the deal) and allowing for the comparison of yields and pricing for offerings that come to market in the same time frame of a similar credit quality, similar program, and/or similar geographic region to their financing.

Reporting module 326 may produce logs, reports, or other information associated with municipal securities. Reporting module 326 may provide reports and graphs to view the structure of a portfolio with the new securities in it or existing securities and generate ideas. Reports and graphs may be of actual portfolios, modeled portfolios, or a combination (e.g., a user portfolio with hypothetical security purchases to model the impact of such purchases). Reports and graphs may include detailed information about a particular security in a primary market, a secondary market, or the history of a security across both a primary and secondary market. Reports and graphs may also include comparative data comparing a security against other securities (e.g., grouped by one or more of rating, maturity, sector, geographic area, etc.). Comparative data may be presented as measured by one or more metrics such as, for example, price, yield, and rating. Examples of graphs may include a graph of maturity distribution that shows where bonds may be added or reduced to maintain a laddered portfolio and portfolio views by one or more of: rating, yield, geography or by sector to identify gaps in holdings. Sectors may include, for example, general obligation, advance refunded, state appropriated debt, education—higher education, education—non-higher education, health, housing, transportation, utilities, water & sewer, and miscellaneous revenue. User interfaces are discussed in greater detail below in reference to FIGS. 8-12.

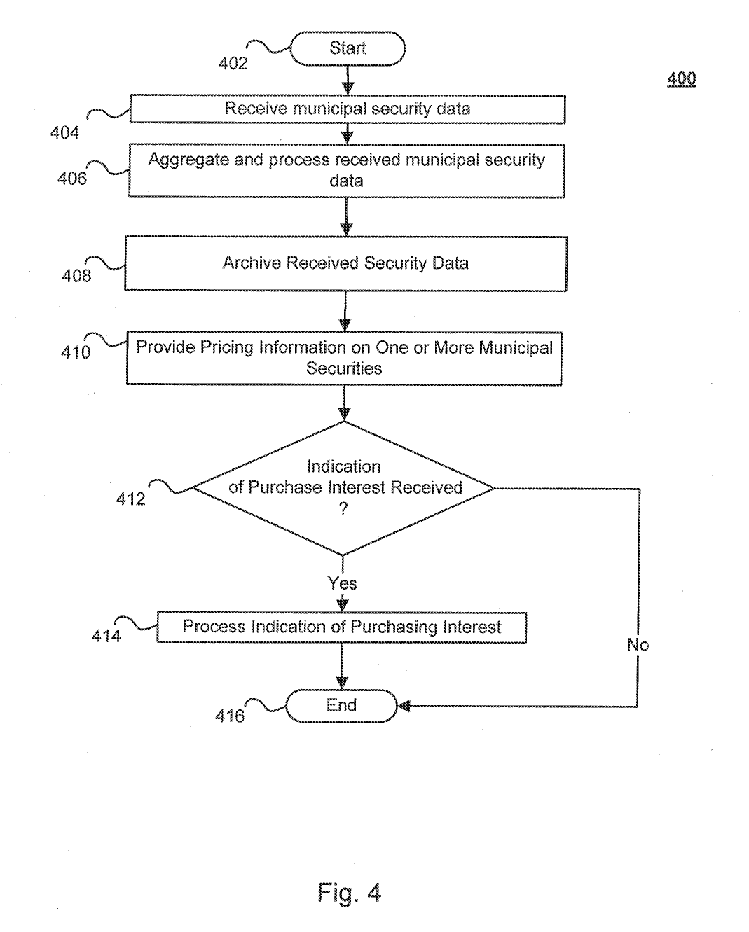

Referring to FIG. 4, there is depicted a method 400 for security data aggregation and trading, in accordance with an embodiment of the present disclosure. At block 402, the method 400 may begin.

At block 404, municipal security data may be received. Information from data providers about securities in the primary market may include, for example: the name of new issues coming to the market when they are announced (e.g., par, pricing date, issuer, public rating); preliminary official statements related to new issues; pricing information on the date of the retail order period and institutional order period for new issues; final pricing information for new issues; final Official Statements for new issues; final credit rating for new issues; publically available issuer disclosures; financial information; material events reporting available outside of the official statement for the issuer filed with the Nationally Recognized Municipal Securities Information Repositorys; and trading activity related to the new issue and relating to the securities of the issuer generally occurring in real time in the secondary market, end of day intra-day trading information for new issues; and a graphical representation of spread compression for the new issue against several municipal market credit quality yield benchmarks and treasury bond market yield benchmarks. According to some embodiments, information may also be received about securities in a secondary market including, for example: final official statements; initial pricing; initial credit ratings; current ratings and ratings history since issuance; current pricing and pricing history since issuance in secondary market trades; history of disclosure filings by an issuer; publically available issuer disclosure and financial information available outside of the official statement on public websites for the issuer; and a an alternative trading platform, or other alternative trading systems, which inventory the outstanding secondary market offerings available for purchase.

At block 406, municipal security data may be aggregated and processed. Municipal security data may be filtered, analyzed, or otherwise processed. A proprietary curve fitting model may be generated to record yield levels in a primary market, a secondary market, or in one or more user specified segments of a market. Such proprietary methodology may enable the generation of a curve that is capable of showing the changing average yields by one or more attributes such as, for example, credit quality, geography, and sector based on end-of-day new issue pricing every day. Yield curves may be based on actual pricing data on the close of every business day based on market activity for issuers in the nation by credit quality tied to the global ratings scale of the major rating agencies—Standard & Poor's, Moody's and Fitch. The yield curve may use options adjusted analysis of other identifying criteria of municipal securities.

At block 408, security data may be archived in a database or other electronic storage. Archival of data may allow analysis of a security, a group of securities, a sector of a market, or an index or aggregation of an entire primary or secondary market. Archival of data may allow analysis of the performance of a security issuer, an underwriter, an investment bank, or another financial institution.

At block 410, pricing information may be provided on one or more municipal securities. Pricing information may allow customers to see a new data-line market index on the web portal and have a benchmark against which to compare yields and pricing information for new issue securities and secondary market securities. Benchmarks may include, for example, Treasury yields, Municipal AAA Yields, Municipal BBB Yields, Revenue Bond AAA yields, Revenue Bond BBB yields, Corporate Aaa yields, and Corporate Baa yields. A yield curve may be presented comprising yield information comparing yields of the municipal security to yields of one or more of the plurality of municipal securities having a same credit rating. A user may analyze a security using present pricing information compared against one or more other securities selected using specified criteria (e.g., a specified credit rating, a maturity date, a price range, a range of yields, a geographic area, a market sector, an underwriter, and an associated investment bank).

At block 412, it may be determined whether an indication of purchase interest or an order has been received. If an indication of purchase interest or an order has been received the method 400 may continue at block 414. If no an indication of purchase interest or order has been received the method 400 may end at 416.

At block 414, an indication of purchase interest or an order may be processed. One or more order validation actions may be performed including, for example, identity verification, verification of ownership of the account verified, and available liquid funds in cash may be verified before the order is submitted to the investment bank and senior manager running an offering.

At block 416, the method 400 may end.

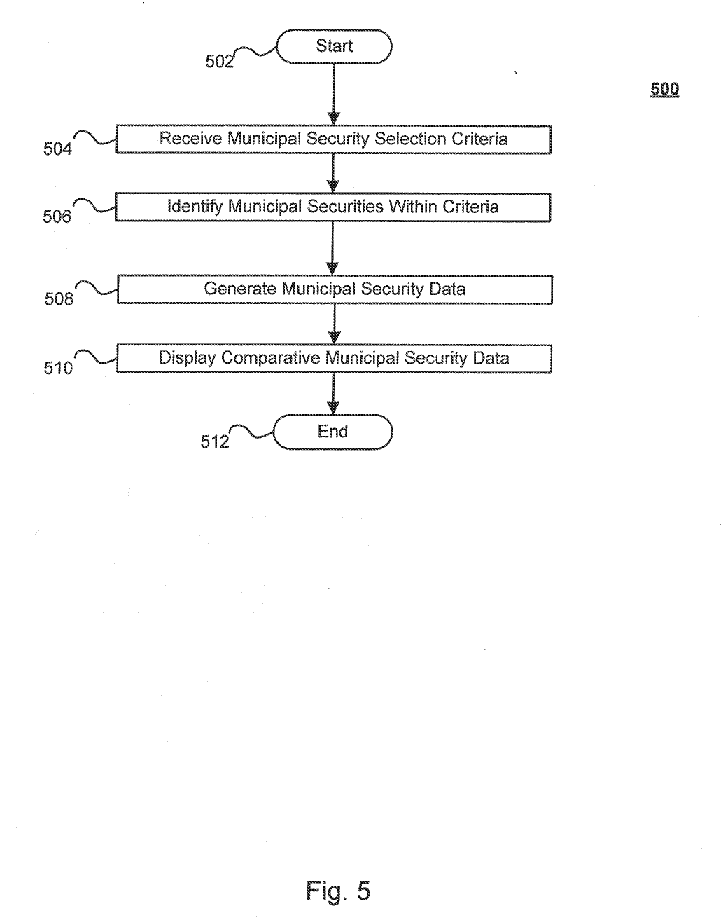

Referring to FIG. 5, there is depicted a method 500 for security data aggregation and trading, in accordance with an embodiment of the present disclosure. At block 502, the method 500 may begin.

At block 504, municipal security selection information may be received via a user interface. Selection criteria may allow a user to group securities in a market by credit rating, price, yield, call risk, maturity date, and other factors.

At block 506, securities falling within the specified security data may be identified. At block 508, security data may be analyzed and performance and price analysis data may be generated.

At block 510, security data may be presented in a plurality of views including detailed views about a particular security or comparative views against one or more other securities, against a market segment, or against a market index. Securities may viewed from a plurality of perspectives such as, for example, from a yield perspective, a price perspective, and a spread perspective (e.g., performance against one or more benchmarks).

At block 512, the method 500 may end.

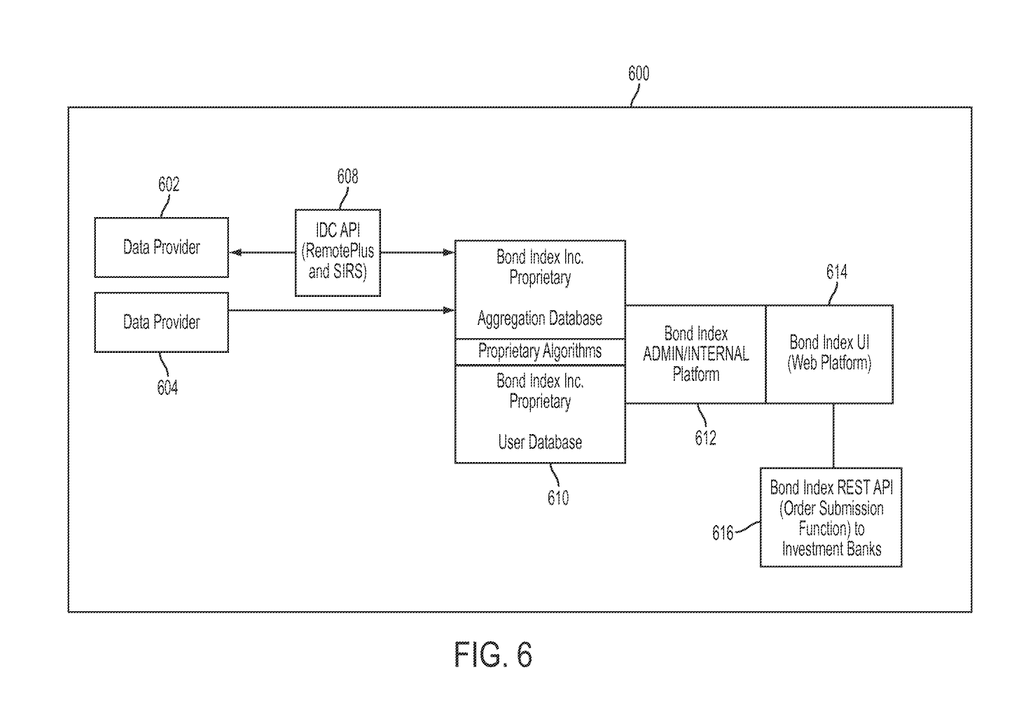

FIG. 6 shows a block diagram depicting a network architecture for security data aggregation and trading, in accordance with an embodiment of the present disclosure. Network architecture 600 may include data providers 600 and 604, interface 608, security data repository 610, bond index administrative platform 612, bond index user interface platform 614, and bond order interface 616.

Data providers 602 and 604 may provide external municipal securities market data providers (e.g., Interactive Data Corporation, Image Masters, or another financial market data provider). Data providers 602 and 604 may provide municipal security data for primary markets and/or secondary markets. Data providers 602 and 604 may provide one or more interfaces, filters, converters, formatting modules, or other data processing components to prepare data for security data repository 610. Data may be provided periodically (e.g, daily, hourly, real time, or other increments), in batch or bulk, in response to a query or request, or event driven (e.g., in response to an initial offering, a news event, etc.).

Security data repository 610 may be database or other electronic storage. Security data repository 610 may aggregate data for one or more markets and generate pricing and analysis data.

Bond index administrative platform 612 may provide administrative functionality including, for example, user management (e.g., user ids, passwords, roles), storage management, user interface management and design, error notifications, and reporting.

Bond index user interface platform 614 may provide a user interface on one or more platforms. A user interface may be designed for multiple platforms including desktop and mobile embodiments. Clients may be mobile devices implemented on one or more mobile platforms including, but not limited to Android, iOS, WebOS, Windows Mobile, Blackberry OS, and Symbian. Security data aggregation and trading module 154 may be implemented on top of one or more platforms such as, for example, Internet Explorer, FireFox, Chrome, and Safari.

Bond order interface 616 may provide verification of orders and indications and interest and may submit orders and indications of interest to a financial institution for processing. Bond order interface 616 may receive order information and statuses from one or more financial institutions and may forward one or more queries and receive responses from financial institutions.

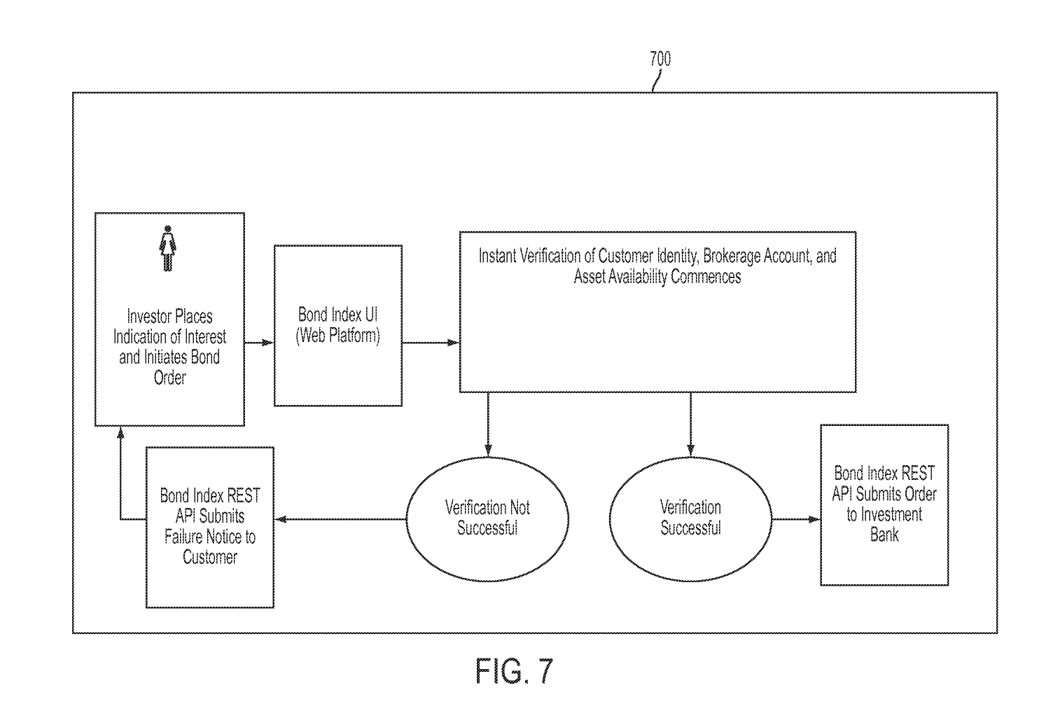

FIG. 7 shows a block diagram depicting a method for verification of municipal securities, in accordance with an embodiment of the present disclosure. Order verification method 700 depicts a work flow process for collecting indications of interest from individual investors, institution investors, and others for submission to financial institutions (e.g., investment banks) during an order period. A user may place an indication or interest or an order via a user interface (e.g., via Bond index user interface platform 614 of FIG. 6). Order verification method 700 may verify that a customer entering an order from any one of multiple brokerage accounts has their identity verified, ownership of the account verified, and available liquid funds in cash. According to some embodiments, verification may be provided via an interface to a third party verification system. If verification is not successful and error message may be returned to a user via a user interface. If verification is successful an indication of interest may be submitted to an investment bank and senior manager running an offering, and such bank may then consider whether to execute the order. Asset verification may be instant.

FIG. 8 depicts a user interface for initiating security trading, in accordance with an embodiment of the present disclosure. As illustrated in FIG. 8, user interface 800 may display an order confirmation message if an order or interest indication is selected. An order may be selected from a screen displaying security details such as, for example, a security maturation date, an initial offering amount, an interest rate, a price, a yield, and a security identifier (e.g., a CUSIP). Graphical information may be provided including a yield of a security versus a benchmark and prices in real time.

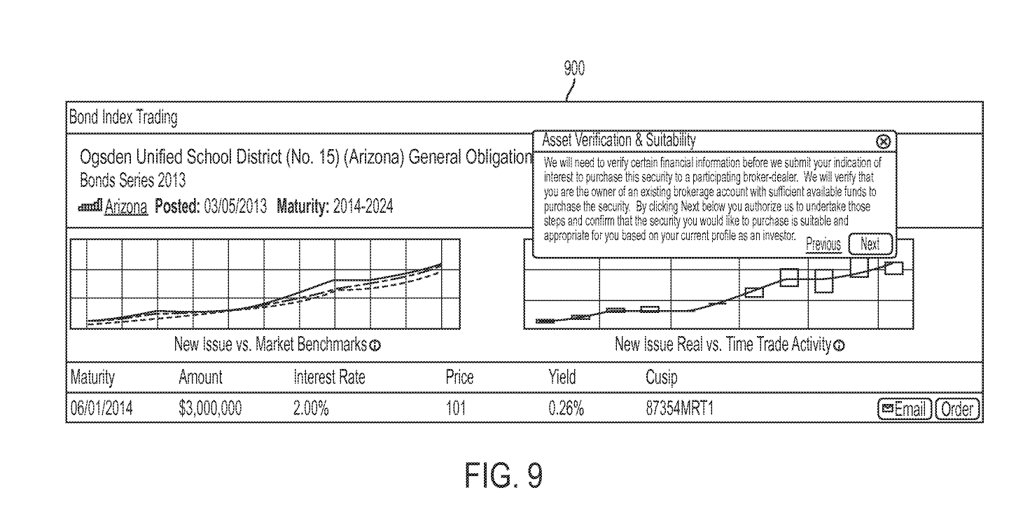

FIG. 9 depicts a user interface for confirmation of initiation of security trading, in accordance with an embodiment of the present disclosure. User interface 900 may display legal information related to a prospective order of a security (e.g., confirmation that asset verification for a purchase is going to be performed) as well as certifications from the investor regarding the suitability of the investment. Such information may be presented overlaid on top of information about a particular security.

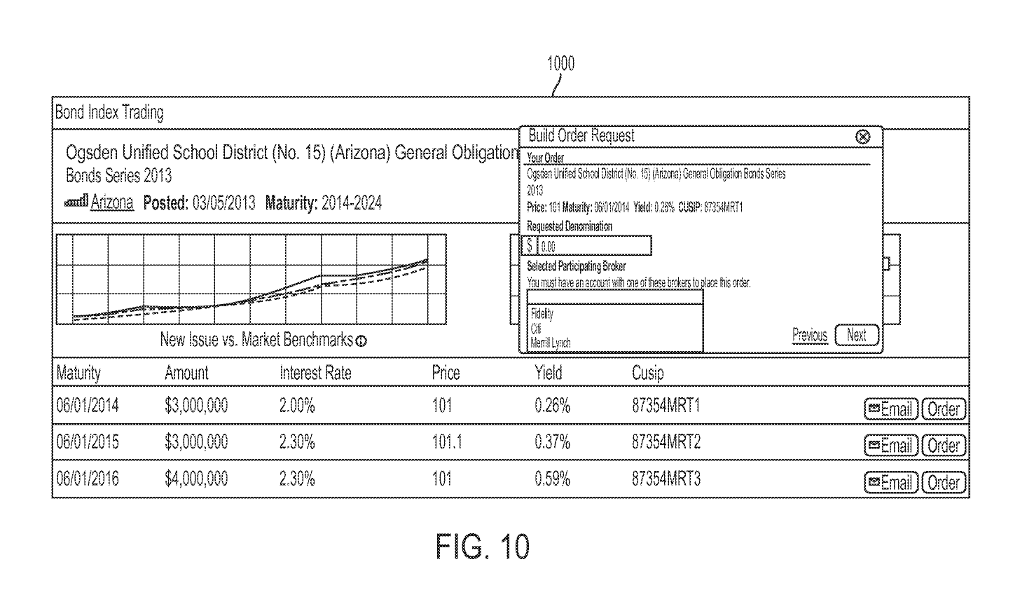

FIG. 10 depicts a user interface for security trading order entry, in accordance with an embodiment of the present disclosure. User interface may gather data for an order, including, for example, a denomination or an amount of a security to be purchased and a financial institution to purchase the security from (e.g., an investment bank).

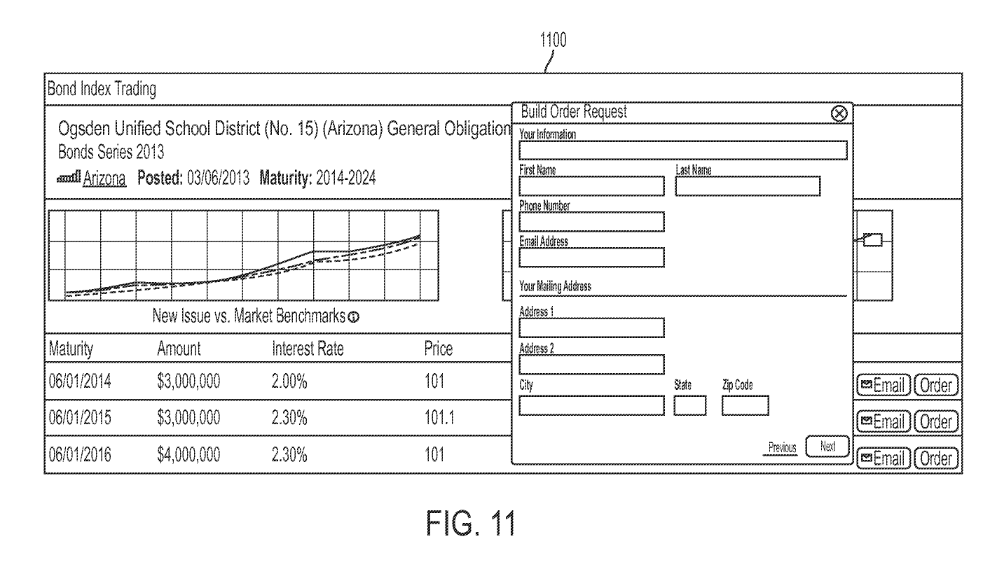

FIG. 11 depicts a user interface for security trading order entry, in accordance with an embodiment of the present disclosure. User interface 1100 may gather further order information including purchaser information (e.g., name, phone number, email address, and address).

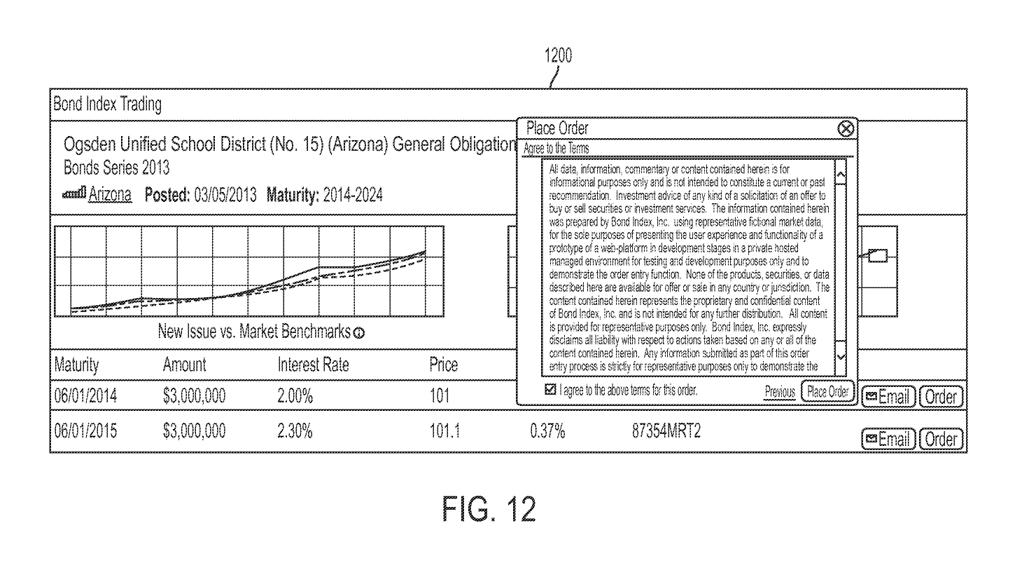

FIG. 12 depicts a user interface for security trading order terms, in accordance with an embodiment of the present disclosure. User interface 1200 may require a user to read an acknowledge purchase terms and to confirm an order or indication of interest.

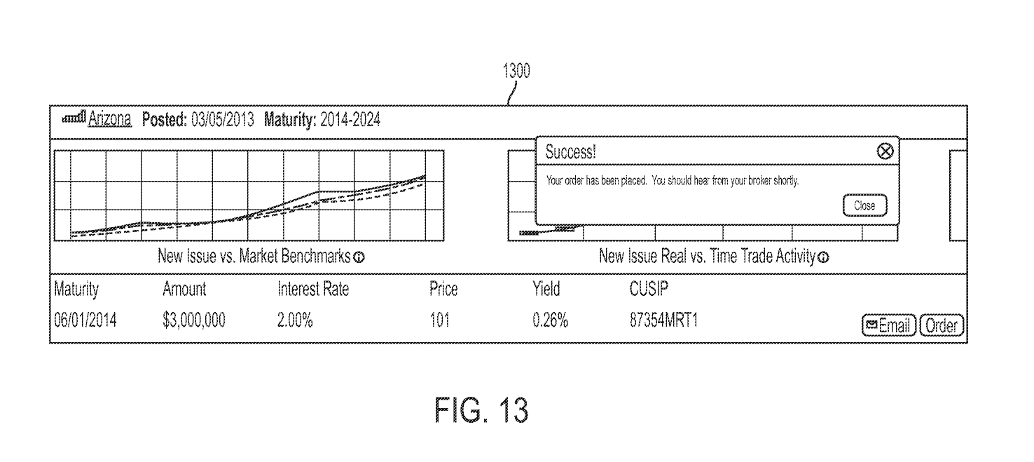

FIG. 13 depicts a user interface for security trading order confirmation, in accordance with an embodiment of the present disclosure. User interface 1300 may provide an order confirmation message, a status message, an error message, contact information, or other order processing information.

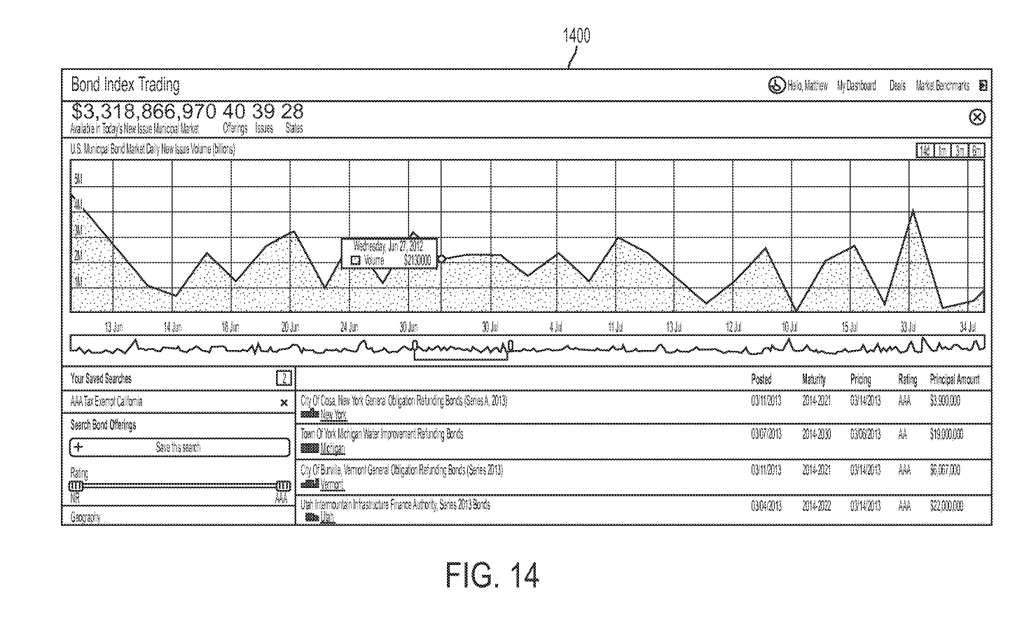

FIG. 14 depicts a user interface for viewing the volume of and the deals in a municipal market, in accordance with an embodiment of the present disclosure. User interface 1400 may provide a municipal security market dashboard. User interface 1400 may provide functionality to view the entire municipal market from a volume perspective and also at the deal level. Information may be presented related to each municipal market offering in real time as deal information is released by the issuer via a preliminary official statement and via syndicate wires. Investors may be able to sort offerings based on distinct municipal market criteria with a side navigation panel powered by a query algorithm. Navigation buttons may be provided to change time frames viewed. Deals may be displayed sortable and queryable by various criteria. Security information on deals may include maturity information, pricing information, rating information, and principal amounts. Deal volume may be displayed graphically and numerically. Deals may be displayed based on based on user saved searches.

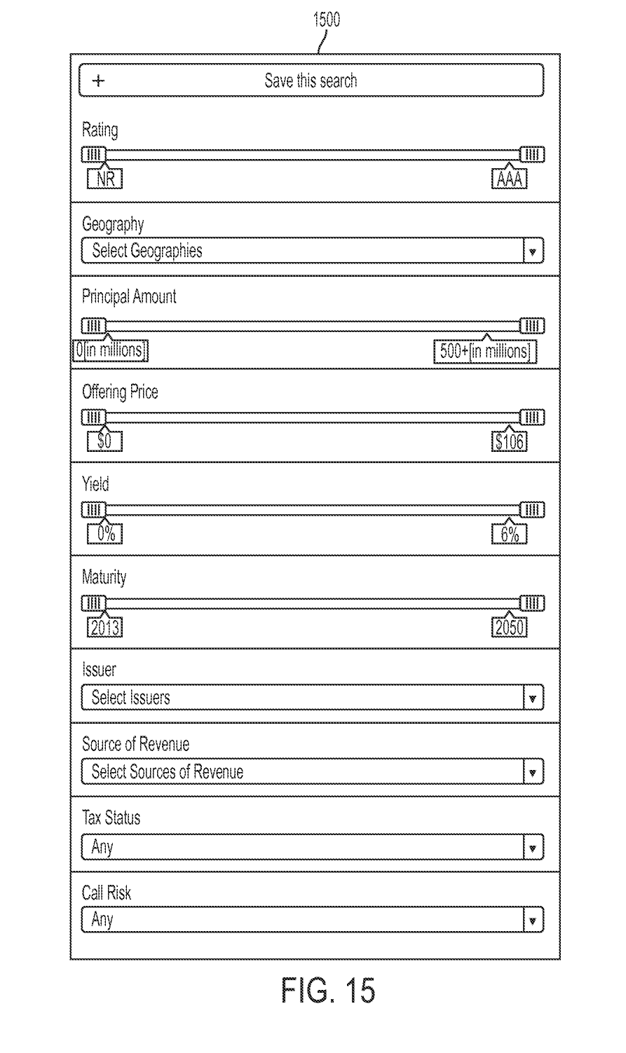

FIG. 15 depicts a user interface for entering securities search and/or filter criteria, in accordance with an embodiment of the present disclosure. User interface 1500 may display criteria used to query securities including, for example, rating, geography, principal amount, offering price, yield, maturity, issuer, source of revenue, tax status (e.g., federally exempt, exempt at a state level, etc), CUSIP, purpose, and call risk. User interface controls may be provided to save a search, view or edit saved searches, delete a saved search, and execute a saved search.

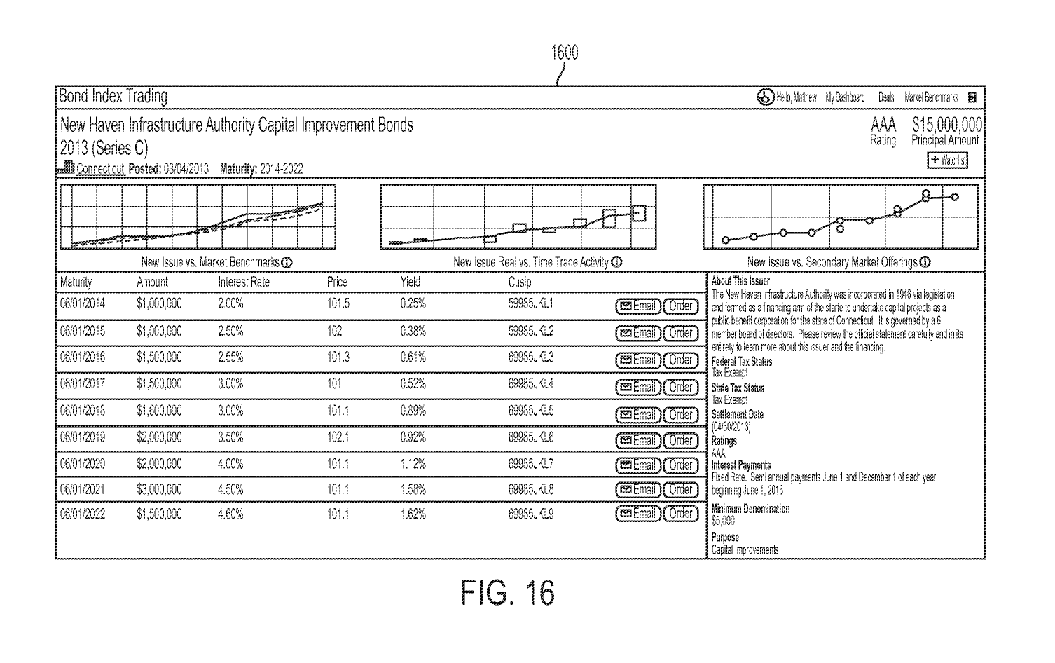

FIG. 16 depicts a user interface for viewing the details of a municipal security offering, in accordance with an embodiment of the present disclosure. User interface 1600 may provide information on a municipal offering. Each municipal offering may have its own dashboard where investors may be able to see all of the offering data that is relevant with respect to the security including, for example: price, maturity, amount, interest rate, yield and cusip presented in tabular form for every maturity in the offering. Additional information for the offering may be presented including: tax status, settlement date, rating, interest payment dates, denomination, purpose and a general description of the issuer. User interface 1600 may also have multiple graphs of data to allow evaluation pricing information. User interface 1600 may provide graphical information on security performance and trading activity. User interface may provide functionality for ordering a security.

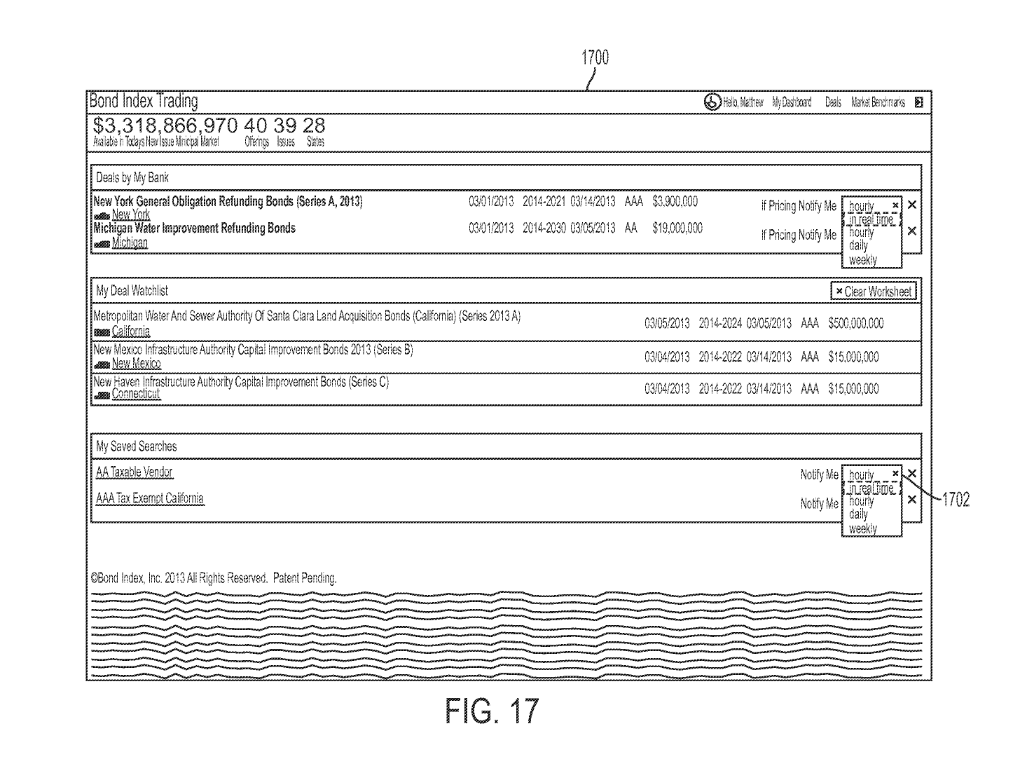

FIG. 17 depicts a user interface for municipal security deals, in accordance with an embodiment of the present disclosure. User interface 1700 provides investors with an additional dashboard to view offerings from banks where their portfolios are located and held. Investors may be able to create a profile with multiple banks selected and see deals auto-populate as the deals reach the market. User interface 1700 may be powered by a single source query algorithm that may run continuous searches sorting the investment bank as a sole element and a separate query algorithm of “Saved Searches” meeting different criteria. Functionality may be provided to specify notification frequency (e.g., daily, hourly, on the basis of specified events or thresholds), contact information, preferred contact methods, and other notification preferences. Different panels may be provided (e.g., a deal watch list, a saved searches list, a market blog, deal inquiry and question submission functionality, etc.).

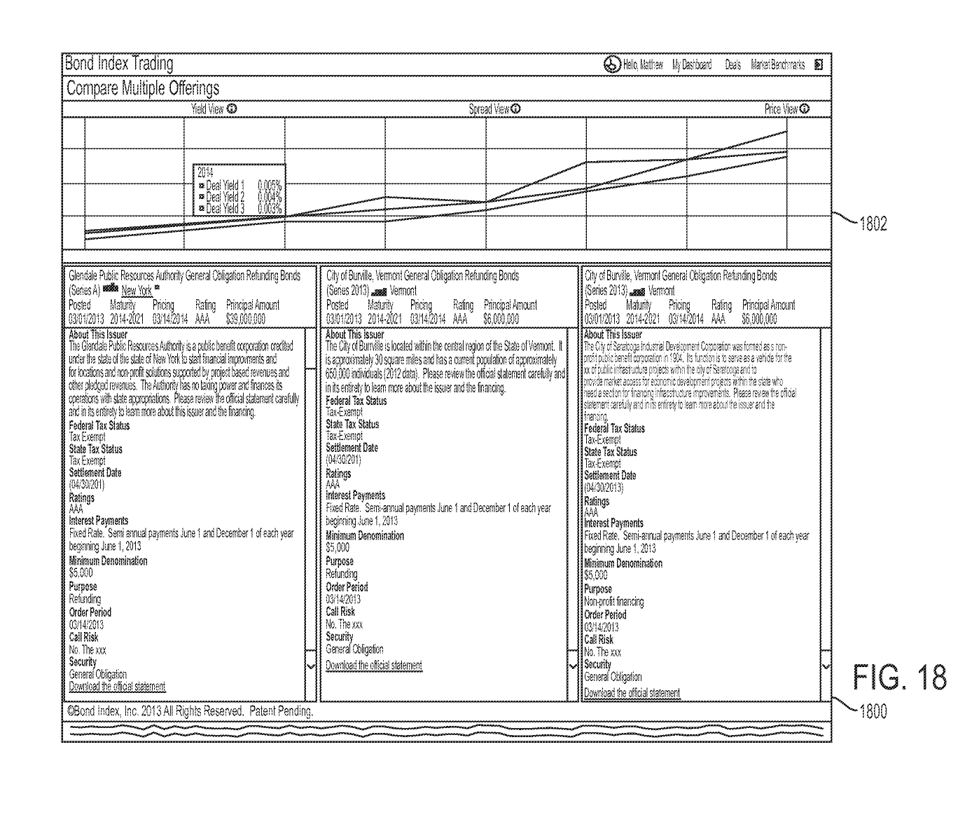

FIG. 18 depicts a user interface for comparing municipal securities, in accordance with an embodiment of the present disclosure. User interface 1802 provides investors with additional views to compare offering information side by side and generate tables showing critical elements of information including for example: 1. The yields of the offerings plotted against each other “Yield View”; 2. The yields of the offering plotted against the market benchmarks for the credit quality of the issue (“Spread View”; and 4. The price comparison of the offerings (“Price View”). Panels of detailed information about offerings may be provided below the graphical information.

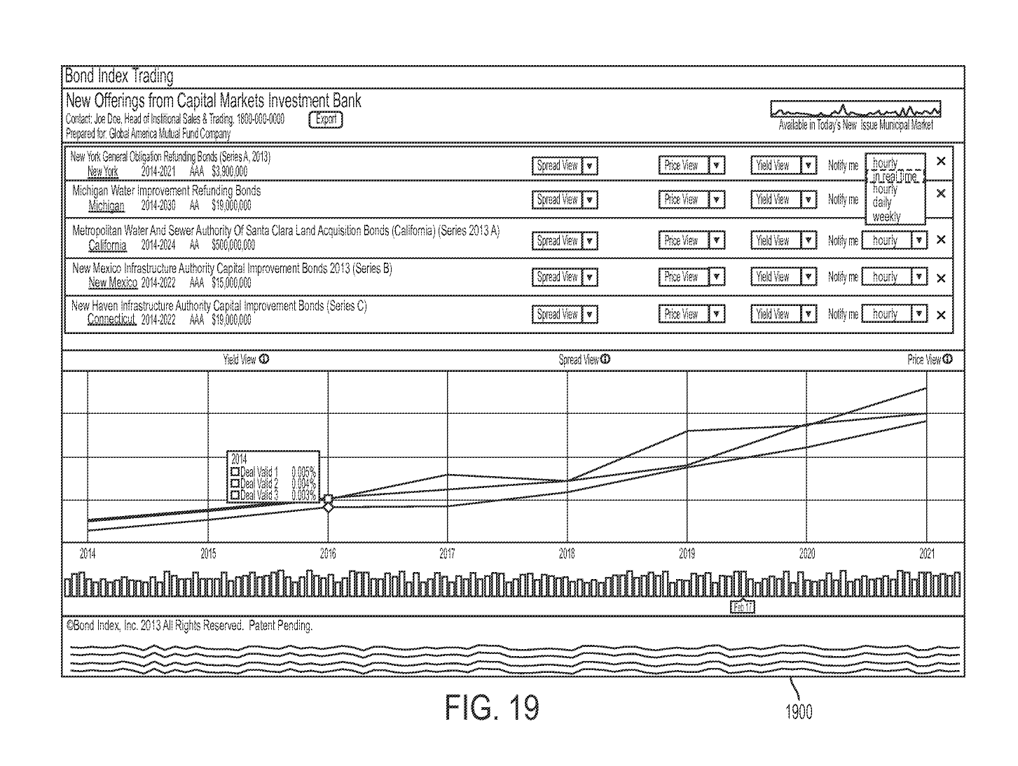

FIG. 19 depicts a user interface for viewing new municipal security offerings of a particular investment bank, in accordance with an embodiment of the present disclosure. User interface 1900 may provide an investment bank custom dashboard that can be exported showing only their offerings to an institutional customer, separate account managers, or other professional high net worth manager of retail assets. Investment Banks Institutional Sales and Trading Staff can add deals by clicking on them and in seconds create a dashboard of offerings by the bank that can be exported as a link to any of their institutional clients—to allow their clients a window into their offerings. The dashboard may auto populate spread, pricing, and yield information from the deals and may allow a user to see the banks inventory daily by clicking on different days. A bar graph may be provided and a horizontal axis of the user interface providing an indication new deals brought to market by the investment bank over a configurable time span. Clicking on a day of the bar graph may bring up the deals for a day.

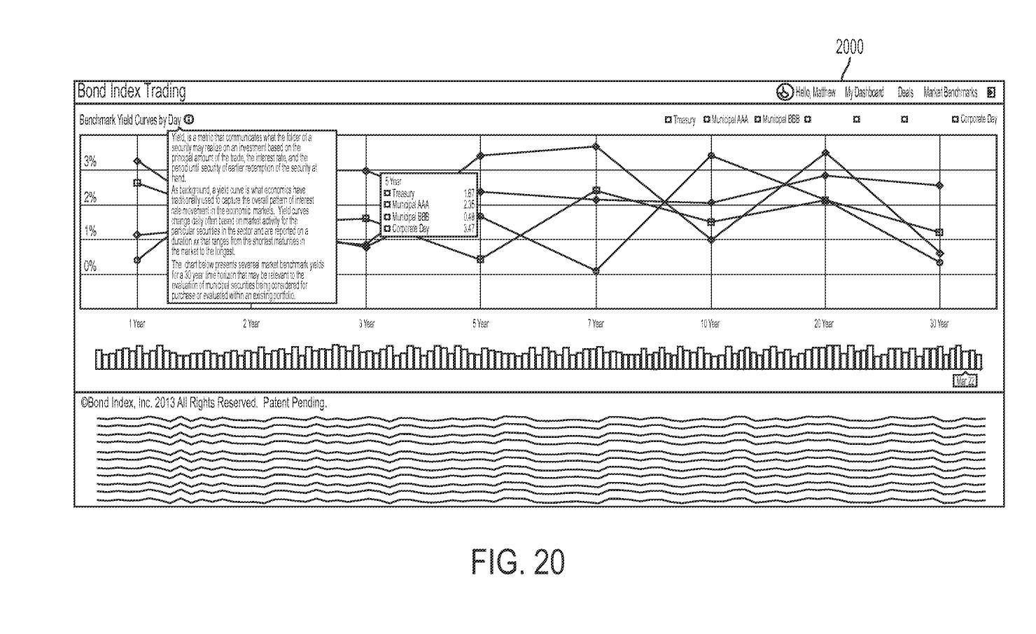

FIG. 20 depicts a user interface for viewing market benchmarks, in accordance with an embodiment of the present disclosure. User interface 2000 may provide market benchmark performances within a configurable timespan (e.g., a 365 day trading window). Investors may be able to view selectable distinct market benchmarks (e.g., Treasury yields, Municipal AAA Yields, Municipal BBB Yields, Revenue Bond AAA yields, Revenue Bond BBB yields, Corporate Aaa yields, Corporate Baa yields) that are relevant to the analysis and evaluation of municipal securities for different duration horizons (e.g., 1 year, 2 year, 3 year, 5 year, 7 year, 10 year, 20 year, 30 year) in the 365 trading day window of the particular day of each offering.

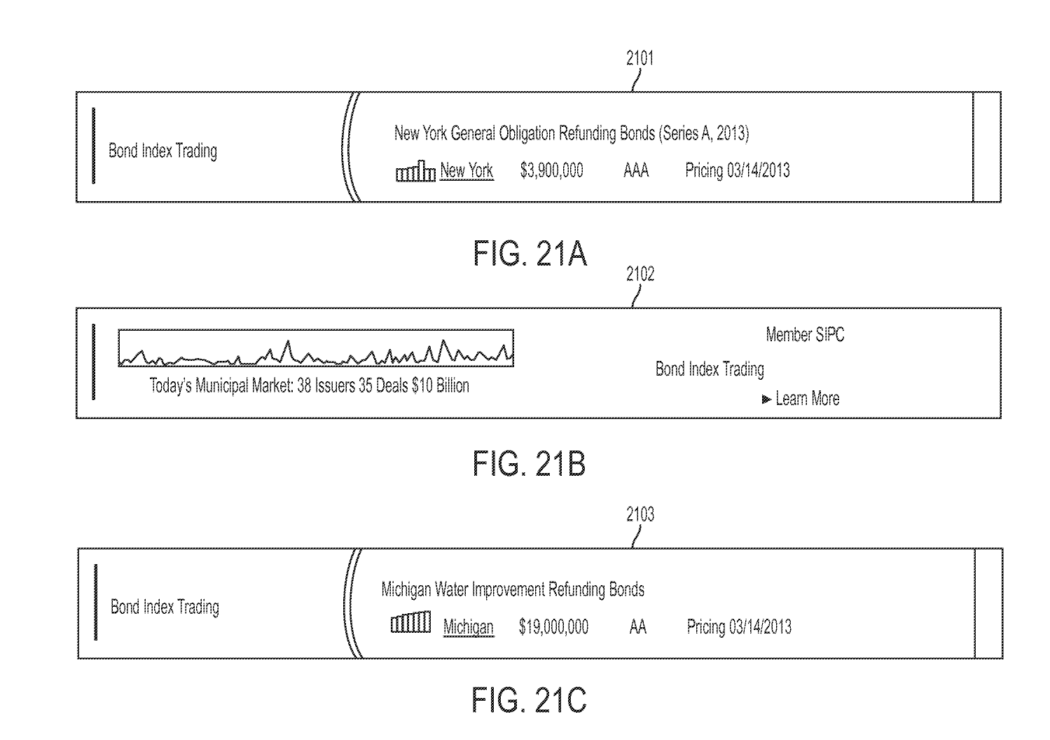

FIG. 21A depicts a user interface for advertising municipal security offerings, in accordance with an embodiment of the present disclosure. FIG. 21B depicts a user interface for advertising municipal security offerings, in accordance with an embodiment of the present disclosure. FIG. 21C depicts a user interface for advertising municipal security offerings, in accordance with an embodiment of the present disclosure. FIGS. 21A-C may be used as a method of advertising in local and national Internet news media for financings where issuers selected such method within the scope of work for the engagement of Bond Index to market the transaction. The banner ads may link to detailed information where individuals may view offerings with the full scope of functionality. A closed version may provide marquee advertising for the company, and it may expand and contract or disappear in part to reveal a financing being marketed. The version could alternate and reveal multiple financings if more than one issuer was present in a jurisdiction at the same time with similar marketing needs. FIGS. 21A-C may also provide information about general market conditions such as, for example, volume, market news, performance against benchmarks and market indexes and indicators.

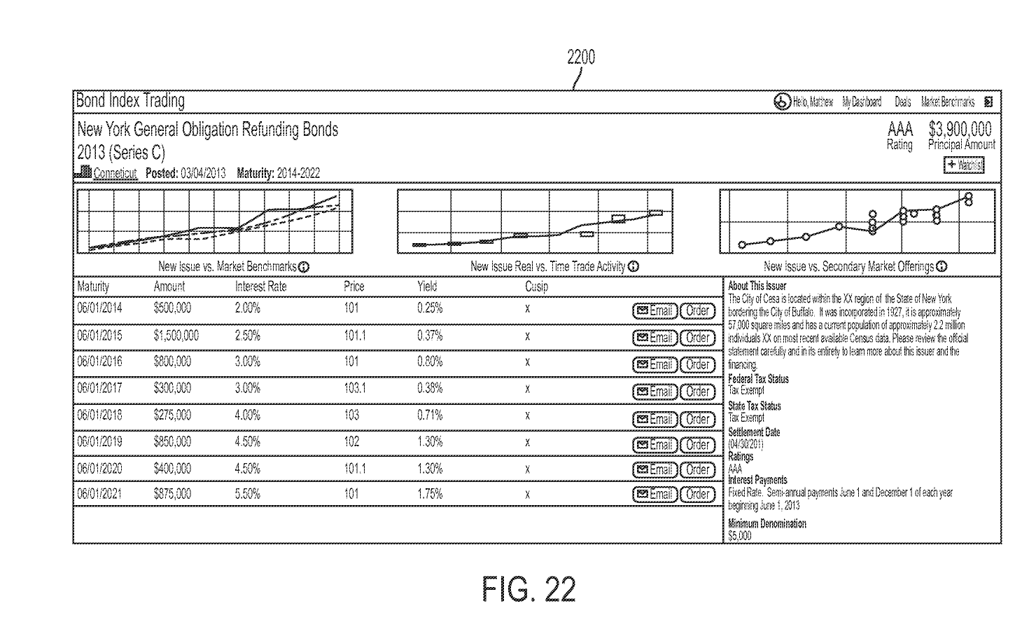

FIG. 22 depicts a user interface for viewing municipal security offering details, in accordance with an embodiment of the present disclosure. User interface 2200 displays an exemplary page providing offering detail in response to an advertisement click that can be viewed throughout the order period.

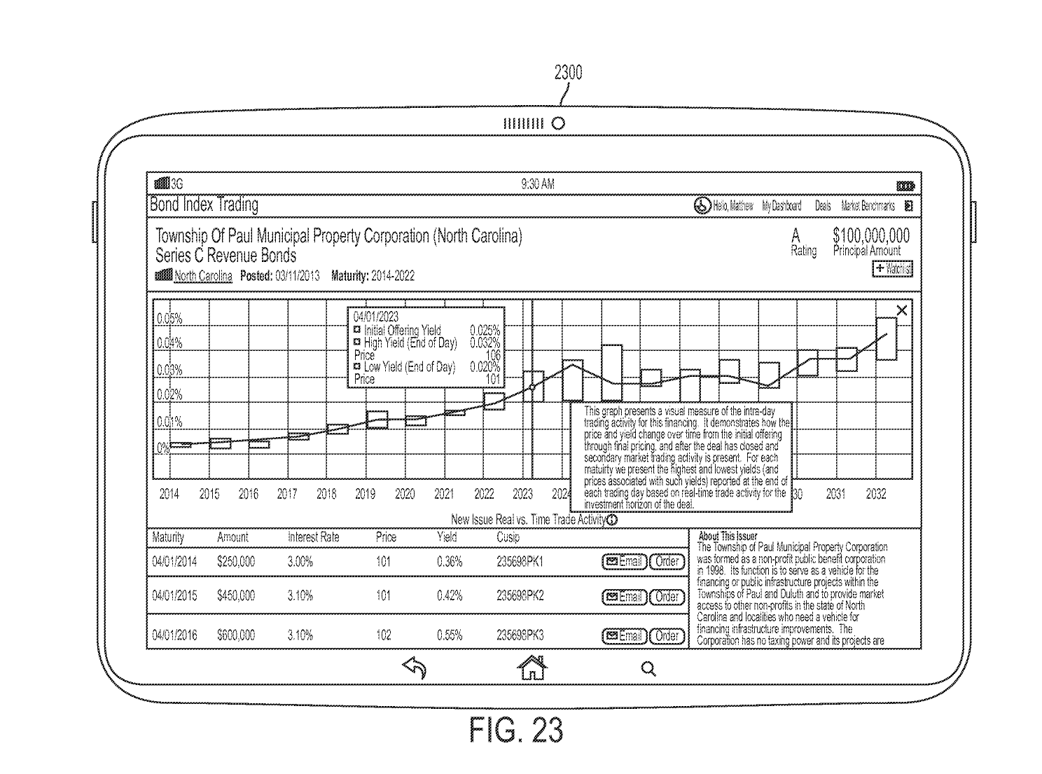

FIG. 23 depicts a mobile user interface displaying a municipal security offering display including measurements of intra-day trading, in accordance with an embodiment of the present disclosure. User interface 2300 displays an exemplary screen displayed on a mobile device. The exemplary screen displays intraday trading activity for a particular financing in a primary market. User interface controls are provided on the interface displayed on the mobile device providing query, display, and order capability.

Other embodiments are within the scope and spirit of the invention. For example, the functionality described above can be implemented using software, hardware, firmware, hardwiring, or combinations of any of these. One or more computer processors operating in accordance with instructions may implement the functions associated with generating and/or delivering electronic education in accordance with the present disclosure as described above. If such is the case, it is within the scope of the present disclosure that such instructions may be stored on one or more non-transitory processor readable storage media (e.g., a magnetic disk or other storage medium). Additionally, modules implementing functions may also be physically located at various positions, including being distributed such that portions of functions are implemented at different physical locations.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

1. A method for municipal security data aggregation comprising:
receiving, via a network, municipal security data regarding a plurality of municipal securities in a primary market;
aggregating, using at least one computer processor, the received municipal security data; and
providing pricing information on a municipal security of the plurality of municipal securities in the primary market.

2. The method of claim 1, further comprising:
receiving an indication of interest in purchasing the municipal security.

3. The method of claim 2, further comprising:
notifying a purchaser that the received indication of interest has been converted into an order.

4. The method of claim 1, wherein the pricing information includes comparative data to evaluate the municipal security relative to a market benchmark.

5. The method of claim 4, wherein the market benchmark comprises at least one of: Treasury yields, Municipal AAA Yields, Municipal BBB Yields, Revenue Bond AAA yields, Revenue Bond BBB yields, Corporate Aaa yields, and Corporate Baa yields.

6. The method of claim 1, wherein the pricing information includes comparative data to evaluate the municipal security relative to one or more of the plurality of municipal securities in a primary market.

7. The method of claim 6, wherein the comparative data comprises yield information.

8. The method of claim 7, wherein the yield information comprises yield information comparing yields of the municipal security to yields of one or more of the plurality of municipal securities having a same credit rating.

9. The method of claim 7, wherein the yield information comprises yield information comparing yields of the municipal security to yields of one or more of the plurality of municipal securities having a same geographic segment.

10. The method of claim 7, wherein the yield information comprises yield information comparing yields of the municipal security to yields of one or more of the plurality of municipal securities having a same sector.

11. The method of claim 10, wherein the sector comprises at least one of: general obligation, advance refunded, state appropriated debt, education—higher education, education—non-higher education, health, housing, transportation, utilities, water & sewer, and miscellaneous revenue.

12. The method of claim 6, wherein the comparative data comprises price information.

13. The method of claim 1, further comprising:
providing a search functionality configured to identify a municipal security out of the plurality of municipal securities in the primary market having a specified criteria including at least one of: a geographical attribute, a price, an issuer, a yield, a rating, a Committee on Uniform Security Identification Procedures (CUSIP) code, a source of revenues, a federal tax status, a state tax status, a duration, a purpose, an insurance status, and a call risk.

14. The method of claim 1, further comprising:
receiving, via a network, municipal security data regarding a plurality of municipal securities in a secondary market;
aggregating, using at least one computer processor, the received municipal security data; and
providing pricing information on a municipal security of the plurality of municipal securities in the secondary market.

15. The method of claim 1, wherein the municipal security data is received via periodic feeds providing data on at least one of: a daily basis, an hourly basis, and a real time basis.

16. The method of claim 1, further comprising:
importing data modeling a security portfolio; and
providing functionality to model an impact of adding a municipal security of the plurality of municipal securities to the security portfolio.

17. The method of claim 16, further comprising:
identifying, using specified criteria, a municipal security of the plurality of municipal securities.

18. The method of claim 17, wherein the one or more specified criteria include maturity date information for one or more of the plurality of municipal securities, wherein the maturity date information allows laddering modeling functionality.

19. The method of claim 1, further comprising archiving data, using at least one database, for the plurality of municipal securities in the primary market.

20. The method of claim 19, further comprising evaluating at least one issuer of a municipal security of the plurality of municipal securities on one or more metrics using the archived data.

21. The method of claim 20, wherein the one or more metrics comprise: net interest cost for a financing, true interest cost for a deal, a comparison of yields and pricing for offerings that come to market in a same time frame of a similar credit quality, similar program, and similar geographic region to a financing.

22. An article of manufacture for municipal security data aggregation, the article of manufacture comprising:
at least one non-transitory processor readable storage medium; and
instructions stored on the at least one medium;
wherein the instructions are configured to be readable from the at least one medium by at least one processor and thereby cause the at least one processor to operate so as to:
receive, via a network, municipal security data regarding a plurality of municipal securities in a primary market;
aggregate, using at least one computer processor, the received municipal security data; and
provide pricing information on a municipal security of the plurality of municipal securities in the primary market.

23. A system for municipal security data aggregation comprising:
one or more processors communicatively coupled to a network; wherein the one or more processors are configured to:
receive, via a network, municipal security data regarding a plurality of municipal securities in a primary market;
aggregate the received municipal security data; and
provide pricing information on a municipal security of the plurality of municipal securities in the primary market.

24. The system of claim 23, wherein the one or more processors are configured to:
receive an indication of interest in purchasing the municipal security.

25. The system of claim 23, wherein the pricing information includes comparative data to evaluate the municipal security relative to a market benchmark.

26. The system of claim 23, wherein the pricing information includes comparative data to evaluate the municipal security relative to one or more of the plurality of municipal securities in a primary market.

27. The system of claim 26, wherein the comparative data comprises yield information comparing yields of the municipal security to yields of one or more of the plurality of municipal securities having at least one of a same credit rating, a same geographic segment, and a same sector.

28. The system of claim 23, the one or more processors are configured to:
provide a search functionality configured to identify a municipal security out of the plurality of municipal securities in the primary market having a specified criteria including at least one of: a geographical attribute, a price, an issuer, a yield, a rating, a Committee on Uniform Security Identification Procedures (CUSIP) code, a source of revenues, a federal tax status, a state tax status, a duration, a purpose, an insurance status, and a call risk.

29. The system of claim 23, the one or more processors are configured to:
import data modeling a security portfolio; and
provide functionality to model an impact of adding a municipal security of the plurality of municipal securities to the security portfolio.
